(19) United States
(12) Patent Application Publication
(10) Pub. No.: US 2007/0027784 A1
(43) Pub. Date: Feb. 1, 2007

(54) Network payment framework

(75) Inventors: Alfred Kahn IV, Denver, CO (US); David S. Johnson, Denver, CO (US)

Correspondence Address: HOGAN & HARTSON LLP;IP GROUP, COLUMBIA SQUARE, 555 THIRTEENTH STREET, N.W., WASHINGTON, DC, 20004, US

(73) Assignee: IP Commerce

(21) Appl. No.: 11/492,887

(22) Filed: Jul. 26, 2006

Related U.S. Application Data
(60) Provisional application No. 60/702,355, filed on Jul. 26, 2005.

(51) Int. Cl. G06Q 40/00

(52) U.S. Cl. 705/35

(57) ABSTRACT

An IP payments platform and methods for implementing a services network using Internet Protocol (“IP”) for integrating applications enabling users to build, collaborate, provision, and manage payments directed at specific customer segments, transaction sockets, and devices. for providing a managed service set of core capabilities and communication interfaces. Multiple IP payments platforms may be interconnected through peered connections to form a payment services network. Users and participants may connect with the payment services network over common IP interfaces. Methods are provided for the creation, management and provisioning of services within the payment services network, as well as the collaboration of the participants and end-users.

### CROSS REFERENCE TO RELATED APPLICATION

This application claims benefit of U.S. Provisional Application No. 60/702,355 entitled “NETWORK PAYMENT FRAMEWORK” and filed Jul. 26, 2005, which is hereby incorporated by reference.

### BACKGROUND OF THE INVENTION

1. Field of the Invention

The present invention relates to a system and method for Internet Protocol Payments Framework, and more particularly, to a system and method for a distributed services network for building a payment network, collaborating, provisioning, and managing payments through specific customer segments, transaction sockets and devices.

2. Discussion of the Related Art

Current payment networks operate primarily using firmware terminals with dial-up modems. With only a few exceptions it is a one-way communications network. Today's payment network includes a number of proprietary message formats used to route transactions between a point of service and the back-office system. Also, various proprietary software applications are written and employed to communicate with third-party service providers. The net result is a patch work of integrations, bridges, and work-arounds. A merchant's ability to easily switch processors can be limited as could be a merchant's ability to converge their commerce through multi-channel and multi-service payment integration.

A payment represents the final and successful culmination of any activity between consumers and/or businesses. Put another way, payment is the final step in a series of transactional communications or activities. Increasingly, these intermediate activities are conducted automatically over broadband connectivity and are mediated using software applications. The most basic example of this is the home computer user who orders and pays for a product from an eCommerce Website through a DSL connection.

The electronic payments industry has traditionally relied on credit cards as the primary engine for growth. The credit card was arguably one of the preeminent financial service innovations of the 20th century and has been one of the most profitable products in banking for decades now. In fact, it typically ranks as a bank's second largest revenue center. However, by all accounts the credit card account base has reached saturation on the issuing side of the business. Evidence of such saturation can be seen in the endless barrage of mass mailings that have a response rate approaching zero. Not only has the proliferation and commoditization of these cards resulted in sluggish growth and churn, but the overhead for bringing new services through existing network systems has made innovation almost unthinkable. Bundle offerings such as reward cards and dual cards now represent the most important strategies for bank consumer finance offerings. While card associations seek to improve the revenue for their bank members and publicly justify the fee increases associated with these premium product offerings, merchants are mounting pressure on the fixed pricing system that subsidizes card rewards programs.

To compound this, banks have traditionally viewed payments from a consumer's checking account as a completely separate product from payments that involve credit. This is a bifurcation within the bank only, as consumers who increasingly have access to unique financing terms for each individual purchase transaction, view payment options holistically and do not make decisions based on how products have been compartmentalized by their providers.

The right framework solution will allow providers to design, build and manage complex services across the converging commerce landscape of customer present and customer not present transactions. A framework will empower providers to aggregate, provision and manage services for their customers regardless of payment on-ramp, network or device.

Despite the challenges facing today's payments systems, the number of businesses accepting electronic payments has doubled in just 5 years to approximately 6 million. This torrent of customer demand is currently funneled into an economy in which identical functions are provided by hundreds of players with systems which are unable to communicate with one another. The current landscape of electronic payments is analogous to the Russian railroad at the turn of the 20th century in which a variety of rail systems had been built using incompatible tracks of differing track size. Although they all supported a train, each rail gauge was different resulting in all manner of impractical operations overhead in transporting cargo across Asia.

Inefficiencies in today's payment systems result in effective transaction rates that would be hard to accept in any other realm of business. These inefficiencies give rise to unpleasant, and initially unintended, conditions: lack of visibility, universally prohibitive barriers to entry and churn.

First, the high effective transaction rates have prevented the payment process itself from being described to the general market. High fees that may not be perceived as having a favorable price-to-cost ratio are typically left in a black box, shrouded in mystery. Few electronic payment users, on the buy or acquire side, have any understanding of how the process actually works.

Secondly, because the existing systems are so difficult to integrate with and there are so many of them, few new products and services make it to market. The result is that traditional electronic payments are now a commodity resulting in sales channels competing on price with a system that is not tuned effectively to do so. Attrition and churn account for approximately 30% of a typical banks customer base per year as a result.

Current payment networks typically operate using firmware terminals with dial-up modems. Excluding authorization approvals and settlement exceptions, it is a one-way communication network. One of the most onerous limits on the electronic payments industry today is the proprietary message formats used to route transactions between the POS and the back-office system. These formats have historically been used by payment processors to whom some banks outsource these transactions. The ostensible motivation behind this approach is to reduce a merchant's ability to switch processors in the middle of the standard 36 month contract term. The actual result is that every processor has a unique message format that only works on their system (i.e. their railroad gauge). With over 300 different processor certifications in the US alone, providing ubiquitous coverage is difficult. This is compounded by the various software applications that each vendor employs and may have developed on a one off basis to communicate with 3rd party service providers. The net result is a patch quilt of integrations, bridges and work-arounds.

These factors hinder a merchant's ability to converge their commerce through multi-channel payment integration (such as POS, eCommerce, back office software, Lockbox, etc.). As a result, today's market is characterized by companies that specialize in supporting each payment on-ramp with bank channels sometimes participating and other times not. This is a precarious position to operate in when payment services become more widely available and act seamlessly from multiple intelligent devices and applications acting as service oriented policy controlled agents.

These and other deficiencies exist in conventional payment networks. Therefore, a solution to these and other problems is needed providing a network framework for seamlessly integrating payment applications.

### SUMMARY OF THE INVENTION

Accordingly, the present invention is directed to a services network and methods for using Internet Protocol (“IP”) for integrating applications enabling users to build, collaborate, provision, and manage payments directed at specific customer segments, transaction sockets, and devices. The services network of the present invention includes an IP payments platform, payments transaction layer switching (“PTLS”), a software development kit, transaction sockets, and a market place services forum.

The IP payments platform of the present invention provides a server-side implementation bundle of hardware and software hosted by participants of the services network. In one embodiment the IP payments platform provides a business and policy administration module for managing the use of commerce business rules, service agreements, applications, and provisioning of the IP payments platform. A service broker is also provided for managing the connections between transaction origination applications, instances of the IP payments platform, peered instances of the IP payments platform, participants, and users. A socket administration and monitoring module is provided for managing sockets. Platform management and operations support is provided by a systems and event management module. The payments platform further includes a rating engine, a data mart for managing a reporting service interface, and an application programming interface for integrating third-party applications with platform business logic and data management.

According to another embodiment, a PTLS interface enables the delivery of any existing or future payment tender or service to a Socket without requiring an upgrade of the Socket. In a further embodiment, a software development kit provides access to the functionality and integration with the Sockets, which include devices or software applications that electronically originate a payment transaction. The market place forum provides a communications service allowing participants of the services network to collaborate and partner to deliver services and source end-customer leads.

According to another embodiment of the present invention, a services network is provided using Internet Protocol (“IP”), integrating applications (“Sockets”), and enabling participants of the services network to collaborate, and build, provision, and manage payment (commerce) services. Collaboration is provided by service agreements between multiple parties delivering commerce services to end-users (i.e. Merchants) using a dynamic Services Oriented Architecture (“SOA”) and rules-based service delivery system.

According to a further embodiment of the present invention, a services network and methods are provided enabling the integration of disparate Sockets operated by heterogeneous parties. This integration is provided by enabling the initiating Socket to manage transaction data originated onto the service network by a disparate Socket securely through the services network. The disparate Socket is enabled to originate transactions onto the services network on behalf of the initiating Socket, and the services network securely delivers the resulting transaction data to the initiating Socket for management.

According to another embodiment, commerce services available in the services network can be dynamically published into the market place of participants and end-users within the services network. Availability of a commerce service can be messaged to participants and end-users within the services network. Participants within the services network can collaborate to deliver commerce services to end-users. End-users can request activation of the commerce service through the services network to one or more Sockets. The services network can activate the requested services to enable provisioning of said services to the end-users' Socket(s).

According to a further embodiment, the services network and methods enable participants to target commerce services directed at participants and end-users in specific customer segments, or participants and end-users using specific Sockets. The market place within the services network enables end-users to request activation of these targeted commerce services from their Socket(s). The market place of the services network also enables participants to source and fulfill end-user leads originated from these activation requests.

In another embodiment, the services network and methods enable the provisioning of any existing or future payment service within an abstract service class supported by the Socket, into the Socket, without requiring an upgrade of the existing Socket application. The service network also enables multiple commerce services (“Service Bundles”) across disparate service classes to be provisioned simultaneously.

In a further embodiment, the services network and methods use identity tokens to bind one or more Sockets associated with an end-user of the services network to the Commerce Business Rules established by participants within the service network. The services network implements those business rules when transactions originated by end-user Sockets are sent into the services network.

In another embodiment, the Commerce Business Rules are established through collaboration between participants of the services network. Commerce Business Rules govern service provisioning and transaction flow throughout the services network. Commerce Business Rules also govern the process of collaboration between participants within the service network based on roles and Commerce Business Rule hierarchies.

In another embodiment, Commerce Business Rules govern how participants collaborate within the service network to provision services and Service Bundles to end-users. Instances of the IP payments platform within the services network rate for collection and distribution the units of measure for exchange (i.e. fee revenue) between end-users and participants and/or between participants in the services network based on service agreements established by Commerce Business Rules within a rules hierarchy.

It is to be understood that both the foregoing general description and the detailed description provided below and in the appendices are exemplary and explanatory and are intended to provide further explanation of the invention as claimed but not to narrow the invention.

### BRIEF DESCRIPTION OF THE DRAWINGS

The accompanying drawings, which are included to provide further understanding of the invention and are incorporated in and constitute a part of this specification, illustrate embodiments of the invention and together with the description serve to explain the principles of the invention. In the drawings:

FIG. 1A shows a system view of the payment framework, according to an embodiment of the present invention;

FIG. 1B shows a detailed view of an IP payments platform, according an embodiment of the present invention;

FIG. 2 shows a system view of the payment framework incorporating mobile access, according to an embodiment of the present invention;

FIG. 3 shows a detailed view of the payment framework, according to an embodiment of the present invention;

FIG. 4A shows a detailed view of a management console, according to an embodiment of the present invention;

FIG. 4B shows a commerce business rule management console module, according to a further embodiment of the present invention;

FIG. 4C shows a commerce business rule management console module, according to a further embodiment of the present invention;

FIG. 4D shows a commerce business rule management console module, according to a further embodiment of the present invention;

FIG. 4E shows a management console module, according to a further embodiment of the present invention;

FIG. 5 is a flow diagram showing a method for implementing Commerce Business Rules according to an embodiment of the present invention;

FIG. 6 is a flow diagram showing a method for executing service agreements composed of one or more Commerce Business Rules, according to an embodiment of the present invention;

FIG. 7 is a flow diagram showing a method for publishing commerce services developed governed by service agreements composed of one or more Commerce Business Rules, according to an embodiment of the present invention;

FIG. 8 is a flow diagram showing a method for an initiating Socket to manage transaction data originated onto the service network by a disparate Socket securely through the services network, according to an embodiment of the present invention;

FIG. 9 is a flow diagram showing a method for publishing commerce services to a market place within the services network where participants can source end-user leads originated from activation requests for said services, according to an embodiment of the present invention;

FIG. 10 is a flow diagram showing a method for selecting and dynamically messaging end-users about service availability who can then originate service activation requests from these messages, according to an embodiment of the present invention;

FIG. 11 is a flow diagram showing a method for managing a campaign, according to an embodiment of the present invention;

FIG. 12 is a flow diagram showing a method for creating Service Bundles based on Commerce Business Rules that can be activated and dynamically and automatically provisioned to Sockets through the services network, according to an embodiment of the present invention;

FIG. 13 is a flow diagram showing a method for facilitating the discovery of services and Service Bundles, according to an embodiment of the present invention.

FIG. 14 is a flow diagram showing a method for implementing business rules that govern transaction flow through the services network based on transaction identity tokens bound to the transaction's originating Socket application, and associated end-user and participants, according to an embodiment of the present invention;

FIG. 15 is a flow diagram showing a method for binding participant entities to one or more roles and establishing and enhancing business rules associated with participant role-entity bindings, according to an embodiment of the present invention; and

FIG. 16 is a flow diagram showing a method for implementing and rating for collection and distribution the categorized units of measure for exchange between end-users and participants and/or between participants in the services network based on service agreements established by business rules within a rules hierarchy, according to an embodiment of the present invention.

### DETAILED DESCRIPTION OF VARIOUS EMBODIMENTS

Reference will now be made in detail to various embodiments of the present invention, examples of which are illustrated in the accompanying drawings.

In general, the present invention is directed to a payment services network using Internet Protocol (“IP”) for integrating applications, referred to as “Sockets,” and enabling participants of the services network to collaborate, and build, provision and manage payment (commerce) services. According to an embodiment of the present invention, the payment services network resides securely on the Internet. The payment services network is a federated set of IP payments platform instances peered with one another using IP. The “operating system” of the payment services network are the payment platforms. Participants may choose to license an IP payment platform or simply plug-in to one via a software development kit (“SDK”). Each licensee manages their own instance of the IP payments platform and has the option of hosting their own instance or outsourcing the hosting of their instance to a third party, such as a business process outsourcer (“BPO”) who physically manages the instance on behalf of the licensee. Participants may also choose to use a licensee playing the role of an application service provider (“ASP”). The payment services network provides an expanded network providing a greater variety of services and capabilities to a wider range of users.

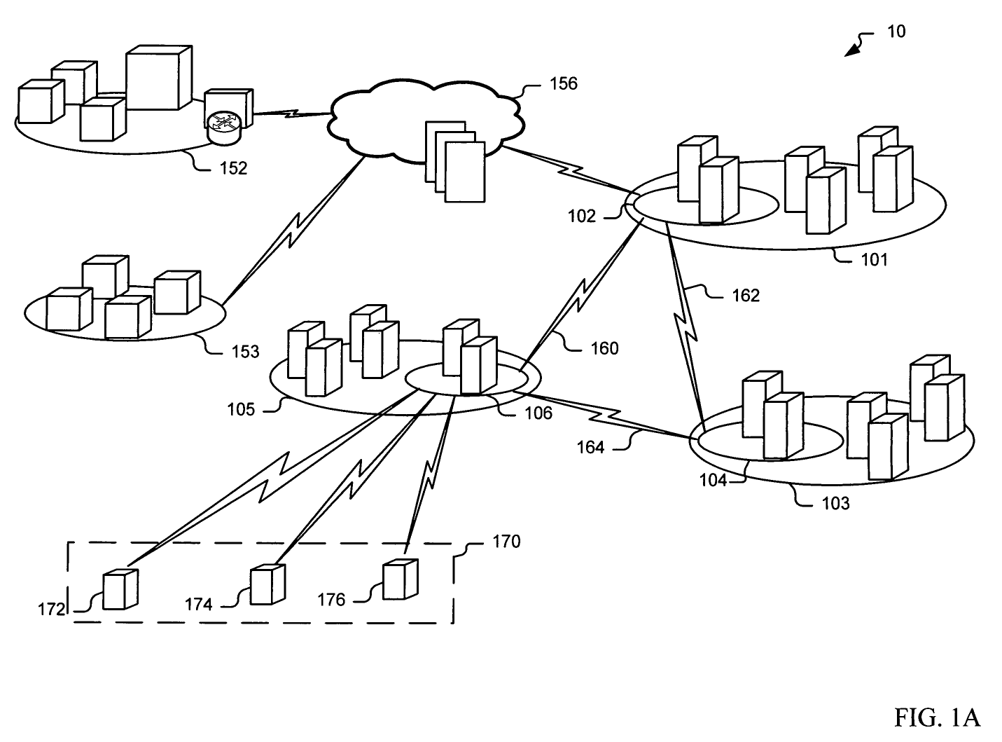

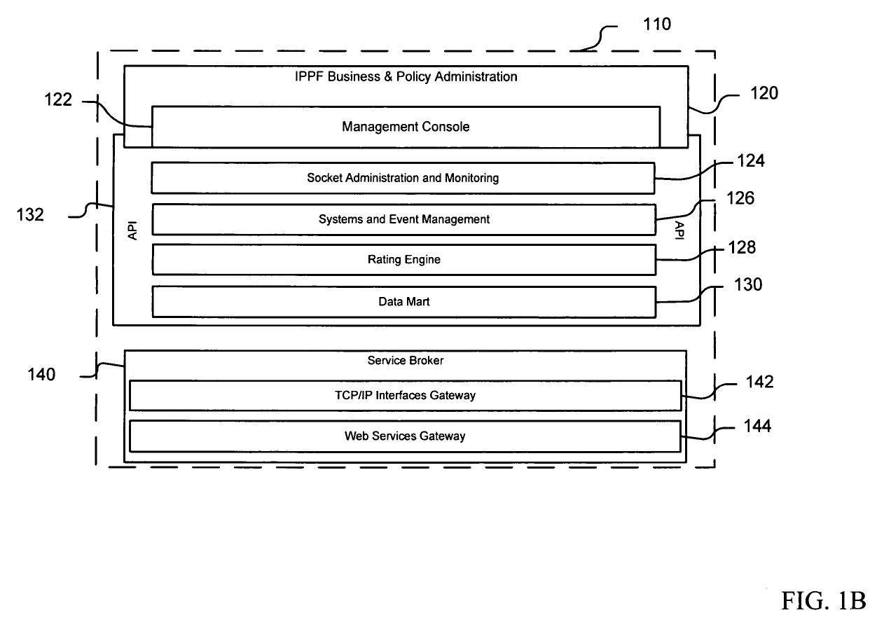

FIG. 1A shows a system view of a payment services network, according to an embodiment of the present invention. As described above, FIG. 1A shows the payment services network 10 incorporating various instances of IP payments platforms 102, 104, and 106 within various participant networks 101, 103, and 105, such as banks, payment processors, or retails, for example. The IP payments platforms 102, 104, and 106 are peered with one another via peer interconnections 160, 162, and 164 to form a service grid.

Each IP payments platform 102, 104, or 106 is a managed service set providing various core capabilities, such as organization management, business rules, service agreements, transaction routing and management, service bundles, order management, operations controls, reporting, rating, an application programming interface, data capture, and merchant storefronts.

The IP payment platform, as shown in FIG. 1A, provides retailers 152, providers of business productivity software 154, Independent Software Vendors (“ISV”) and third party service providers 140, and others to be incorporated into the payment services network via the Internet 156.

Organization management, according to an embodiment of the present invention, allows participants to establish their entity hierarchy, bind roles within the payment framework to these entities, and define internal personnel access, responsibilities and security permissions at distinct levels within the entity hierarchy.

In a further embodiment of the present invention, Commerce Business Rules are created through the selection of a Commerce Business Rule attributes and establishing values to the selected attributes. Commerce Business Rules provide all participants of the payment framework 10 with common standards for operating within the payment framework 10 through partner service agreements, peering alliances, as well as participant defined process requirements and exemptions.

In another embodiment of the present invention, service agreements provide a container for a selection of commerce business rules. Service agreements allow participants to define pricing thresholds, tiers and revenue sharing, and allow each participant, based on their role, to flexibly define their own product/service offering and service bundles in real-time. In another embodiment, collaboration among various service providers is also provided through service agreements between the service providers through the dynamic Services Oriented Architecture (“SOA”) capabilities and rules-based service delivery system of the present invention.

In a further embodiment, transaction routing and management authorizes transactions on the framework for routing directly to processing and settlement networks.

In another embodiment, service bundles allow participants to bundle different payment tenders and services into targeted offerings, within a campaign management process, that are provisioned to specific customer segments as well as define and bind terms to Sockets.

According to an embodiment of the present invention, the IP payments platform provides the core capabilities for the services network, such as order management, operations control, reporting, rating, application programming interfaces, data capture, and merchant storefront

Order management, according to a further embodiment, provides a deployment console that facilitates the merchant activation process and includes Service Level Agreement (“SLA”) notifications and enforcements.

Operations control provides real-time global view and management of the services network from Sockets to processor interfaces with configurable event based logging, notifications and alarms, and performance metrics with segmented system access by support level, and supports escalation process management between participants.

Reporting provides industry standard reporting delivering frequently used reports with export to multiple file formats. Dynamic reporting delivers customized reports and multi-tier reporting segmented by participant and various merchant levels. Consolidated reporting provides data from disparate data providers by accessing said providers simultaneously and in real-time, without the overhead of a centralized data warehouse.

Rating automatically rates for collections and disbursements, monthly service fees, as defined by the participants in their service agreements.

Application programming interfaces allow third party vendors to create applications and tools and allow participants' existing in-house systems to integrate with the IP payments platform thereby providing them access to the services network from their current support, Customer Relationship Manager (“CRM”), and Enterprise Resource Planning (“ERP”) systems.

Data capture provides regulatory compliant capture of transaction metadata for each participant and is accessible through enforced business permissions. This combined with consolidated reporting provides ancillary CRM and Business Intelligence (“BI”) services for participants to merchants and for merchants directly.

Merchant storefront services allow for the creation of a participant branded portal where new services and messaging are provisioned to discreet merchants and where the merchant can activate new services, access their reporting, populate feedback surveys and request customer support.

FIG. 1B shows a detailed view of an IP payments platform 110, according an embodiment of the present invention. According to the embodiment shown in FIG. 1B, the IP payments platform 110 includes a business and policy administration module 120 incorporating a management console 122, a service broker 140 incorporating a TCP/IP interface gateway 142 and a web services gateway 144, a Socket administration and monitoring module 124, a systems and event management module 126 for platform management and operations support, a rating engine 128, a data mart 130 incorporating a reporting service interface, and an application programming interface 132 for integrating 3^{rd} party applications with platform business logic and data management.

As shown in FIG. 1B, business and policy administration module 120 further includes the management console 122 for managing the available services of each instance of the IP payments platform 102, 104, and 106, shown in FIG. 1A. For example, in one embodiment, the business and policy administration module 120 manages the business rules and policies of the IP payments platform and provides for the provisioning, reporting, and administration of its associated IP payments platform.

The service broker 140, TCP/IP interface gateway 142, and web services gateway 144 provide the protocols for standard internet based communications, which in turn provides the framework and interface for communicating over a variety of communication channels and networks. The service broker 140 further provides the message interface for communication between the IP payments platform 110 and Sockets and service providers available within the payment services network, as well as peered instances of the IP payments platform. As shown in FIG. 1A, Sockets may include applications available from retailers with point of service (“POS”) capabilities 152, retailers with business productivity software 153, and various ISV and third-party service providers 170, such as eCommerce Storefront Vendors. In various embodiments, service providers may include stored value providers, and EDI VAN operators. Business applications may also be provided through licensees of the IP payments framework platform. For example, other line of business applications may be provided from a bank hosting an instance of the IP payments framework.

In further embodiments of the present invention, the service broker 140 incorporates payments transaction layer switching (“PTLS”). PTLS is an interface specification that allows any payment service and tender type to be delivered to any Socket. PTLS defines an overall specification for authentication, authorization, security, protocol, message format, operations, and service routing. A transaction node incorporating PTLS provides a PTLS interface specification that allows any payment or service within an abstract service class supported by software or devices to be delivered to the software and devices without the need of upgrading the software or devices.

PTLS supports transaction routing for a federated services grid with dynamic service routing and peering. Peering enables increased service availability across the framework while dynamic service routing enables the framework to deliver transactions to end points based on business rules and service agreements. Service routing is facilitated by transaction message metadata enabling the framework to route transactions without parsing the transaction body portion of the message or requiring specific awareness of transaction message schema. Accordingly, existing proprietary message formats in the market today can be supported within PTLS.

PTLS authorizes an originating entity and the Socket for the use of individual services that have been targeted specifically to a merchant, providing an intentional customer experience. Concurrently, a digital certificate is issued to bind the Socket to the bank or service provider through the implementation of business rules. The use of business rules provides a method to uniquely define customer lock-in by term, Service Bundles, transaction volume thresholds and the like. The use of digital certificates enables the unique identity of the transaction originator to be bound to transactions they originate.

PTLS provides a single, universal interface that can be implemented in a single integration. PTLS was designed specifically for payments, but architected to support the abstraction of market/industry specific dependencies that would limit its future growth. As a result, PTLS is flexible and has been architected to minimize the frequency of engineering required to support new transactions and services. For example, PTLS separates message schema structures of data required by the “payments network” from data required by the service implementation.

In its native state, (meaning when it is not encapsulating a proprietary message format), PTLS can be translated by the framework to the proprietary message format of the end-point it is routed to. This data transformation process means that all existing payment service providers can be supported without any adoption on their part. Over time certain progressive processors may choose to accept PTLS natively on their front-end but it is not a requirement.

While it will be apparent to one skilled in the art that various embodiments may incorporate PTLS encapsulation of proprietary formats and PTLS in its native state individually, in combination with one another, or in combination with other interfaces, the approach of a single interface, such as PTLS, enables applications and operating systems to contain all necessary connectivity to achieve mass market adoption. Furthermore, personal computer/IT distributors may then incorporate a single interface into firmware terminals and other more sophisticated PC POS systems.

In a further embodiment of the present invention, the socket administration and monitoring module 124 enables participants to instantiate, activate, and deactivate sockets registrations with an IP payments platform instance, manage socket messaging, establish and modify provisioned data to be retrieved and by sockets in order to simplify socket provisioning, monitor socket message retrieval and security compliance status, and monitor socket connectivity through the implementation of a periodic network “ping” message originated by the socket to an IP payments platform instance. The socket administration and monitoring module increases the efficiency of participants providing account management and customer support to end-users by providing greater visibility and real-time messaging and monitoring capabilities.

In a further embodiment of the present invention, the systems and event management module 126 provides licensees and 3^{rd} party participants responsible for operating and supporting the IP payments platform with centralized configuration management and event notification and management of the IP payments platform modules and other components such as the service broker or rating engine. The IP payments platform supports highly-available deployment scenarios where multiple instances of a module or component can be deployed in conjunction with standard load-balancing or clustering implementations to mitigate single points of failure. The systems and event management module registers and controls the configuration of each module or component instance to mitigate redundant message processing and ensure that if a module or component becomes unstable or inactive that the load-balancing or clustering implementation becomes aware of the inactive state of the module or component. The systems and event management module also provides event notification to IP payments platform operators and external systems commonly found in the data center environment that perform event notification, such as SNMP or SYSLOG enabled event monitoring systems. Each module and component is pre-configured to provide event notification on a wide variety of events. IP payments platform operators can choose to subscribe to any event associated with any module or component. The systems and event management module automatically adjusts the configuration of all instances of the associated module or component to raise this event when it occurs based on the characteristics defined by the operator when subscribing to the event. When the event occurs, the systems and event management module captures this event and performs the notifications defined by the operator when subscribing to the event, such as sending the event details in an email, SMS notification, or SYSLOG message, or setting and SNMP trap that can be picked up by an external monitoring system. The systems and event management module increases the efficiency of IP payments platform operators by providing a robust, on-demand, subscription based implementation for monitoring system health and facilitating the process of troubleshooting in an operations support environment.

In a further embodiment of the present invention, the rating engine 128 performs the calculation of collections and distributions defined by the service agreements and associated business rules established by participant collaboration. Centralized rating through the IP payments platform provides business practice integrity for all participants by ensuring that all collections and disbursements are rated using the same rules and methods, and that all collections and disbursements are with known parties.

In a further embodiment of the present invention, the data mart 130 persists all transaction metadata for all transactions handled by the IP payments platform. The transaction metadata within the data mart provides a historical view of the activity associated with each transaction including authentication, service authorization, routing, and processing result status. Transaction metadata also includes information about the socket that originated a transaction at the time it was originated. This unique embodiment provides for the first time, real-time visibility into security compliance through the infrastructure of the payment services network. In the existing payments market, visibility into security compliance can only be achieved through expensive and manual onsite auditing. Participants can access data from the data mart using the Management Console 122 or from external applications that are integrated through the API 132 of the IP payments platform

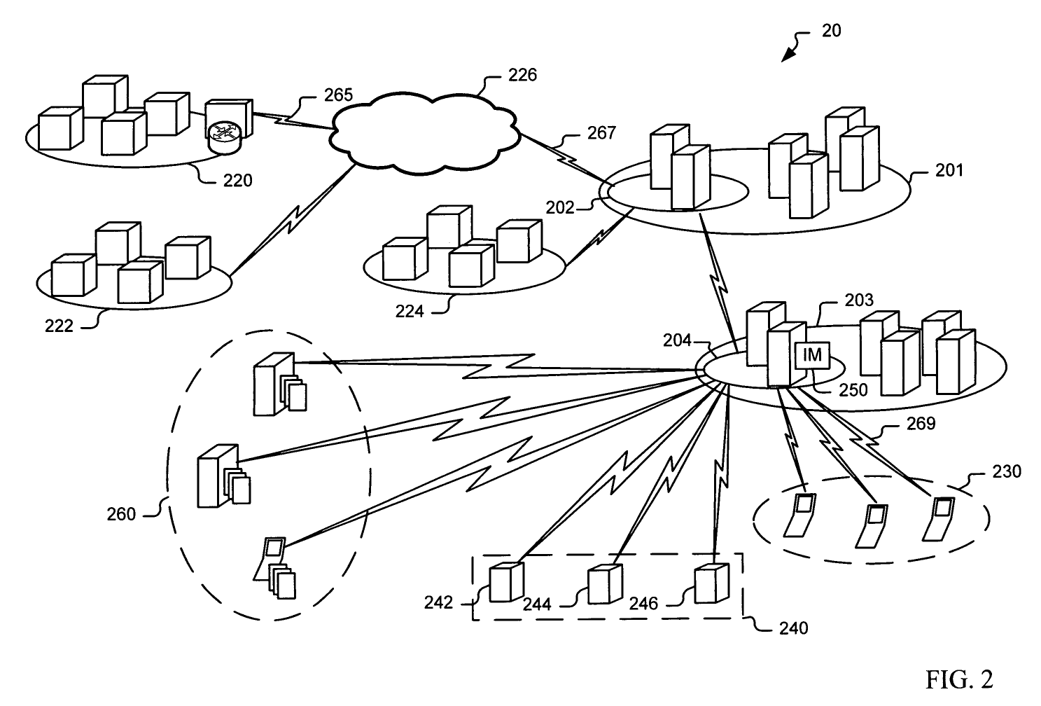

FIG. 2 shows a system view of the payment framework incorporating mobile access, according to a further embodiment of the present invention. The payment framework 20, as shown in FIG. 2, includes IP payments platform licensee networks 201 and 203. Networks 201 and 203 include IP payment platform instances 204 and 202 peered with one another. The licensee networks 201 and 203 also include various servers providing other line of business applications, such as billing and subscriber management, for example.

Various channel partnership networks 220 and 222, such as retail with RMS and Verifone relationships via Telco and VAR, and relationships via ISO channels are enabled via the Internet. Access via the Internet 226 also provides merchant storefronts with web-based administration capabilities. Connection via PTLS is also provided, such as retail vendors with point-of-service merchant relationships via bank direct sales capabilities.

The IP framework platform instance 204, as shown in FIG. 2, also provides mobile device access enabling device to point-of-service payments. Mobile devices 230, such as smart phones and e-mail service devices, communicate with the payment platform instance 204 via PTLS interfaces supported by the service broker. Similarly, the IP payment framework platform enables ISV and Third-party service provider 240 to provide mobile device based services 242, 244, and 246, such as eWallet vendor applications, P2P providers, and Micro Payment providers. Accordingly, as the types of devices used for commerce expand, the payment framework of the present invention provides a configurable framework with which to expand and incorporate new mobile devices and services.

FIG. 2 also provides a software object connecting with an application to a network protocol for use as a Socket for payment processing, according to an embodiment of the present invention. In FIG. 2, an instant messaging (“IM”) 250 service is provided as an example of such an embodiment. The instant messaging service enables the interconnection of IM devices 260, such as phones, smart phones, laptop computers, desktop computers, and other IM capable devices, with an IP payments platform instance to communicate with other IM devices.

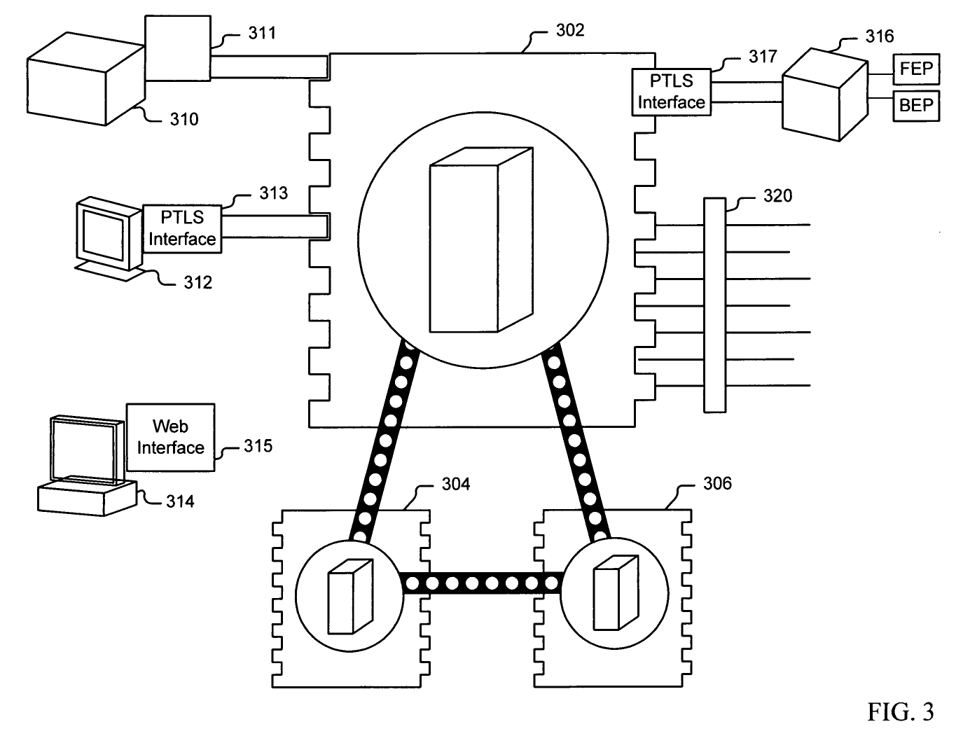

Turning to FIG. 3, a system view of the payment framework is provided, according to an embodiment of the present invention. FIG. 3 shows a peered set of payment framework servers incorporating the payment platform 302, 304, and 306. Payment platform servers 302, 304, and 306 provide a variety of interconnections for banks 310, merchants 312, storefronts and virtual terminals 314 and payment processors 316, and other service providers 320, for example. An SDK 320 is provided for creating an interconnection with the payment services framework 30 using PTLS.

FIG. 3 provides various examples of the PTLS interfaces available with the payment services network of the present invention. For example, the banks 310 are interconnected via a PTLS interface 311, the merchants 312 are connected via a PTLS interface 313, the storefront and virtual terminals 314 are interconnected via a PTLS interface 315, and the payment processors 316 are interconnected via a PTLS translator 317. The SDK via PTLS 320 provides core interconnection capabilities for allowing a variety of applications to be created and adapted into the payment services network 30.

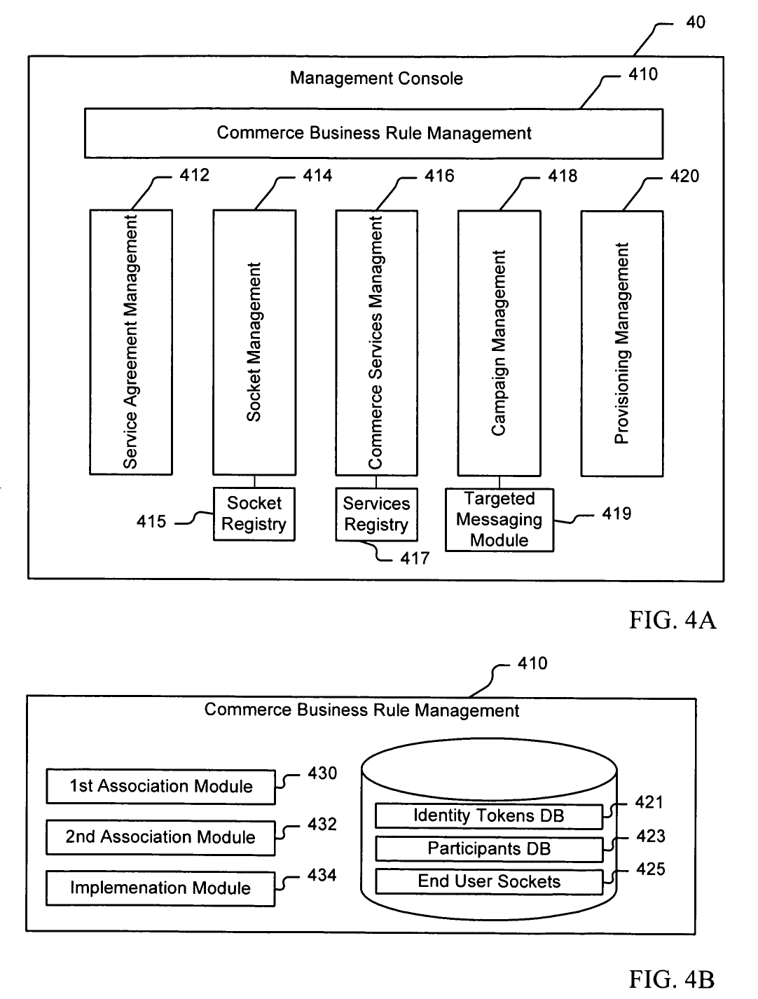

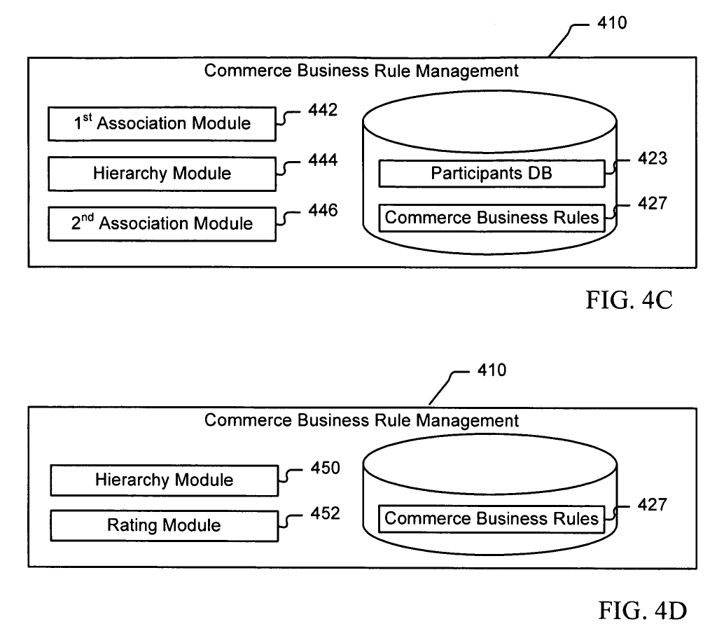

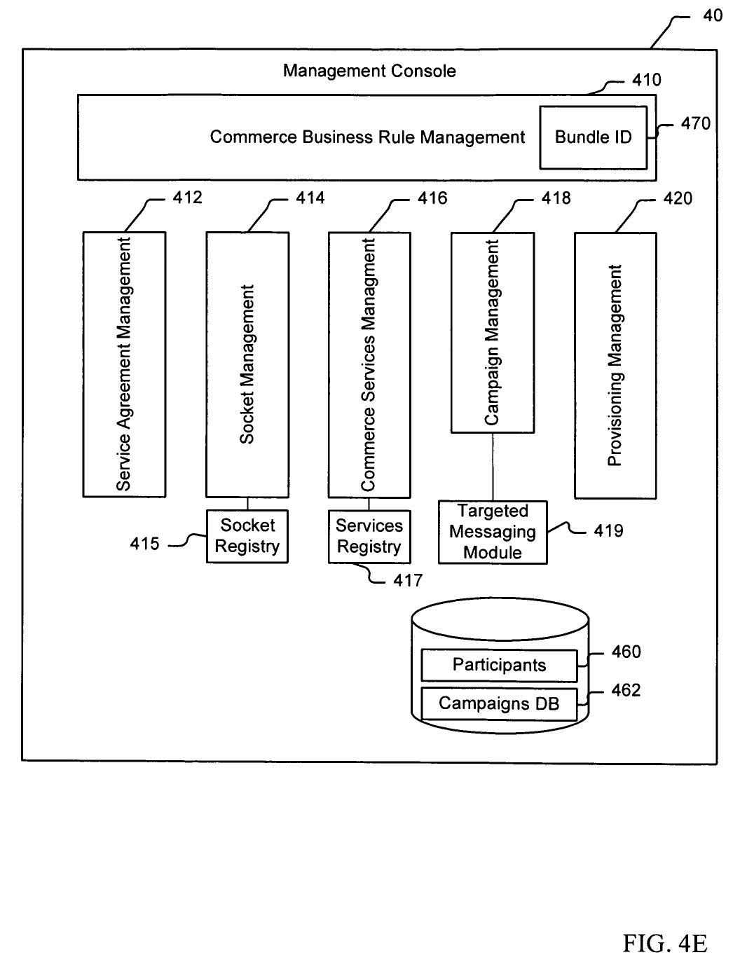

FIG. 4A shows a detailed view of the management console, according to an embodiment of the present invention. The management console 40, as shown in FIG. 4A, provides a Commerce Business Rule management module 410, a service agreement management module 412, a Socket management module 414, a commerce services management module 416, a campaign management module 418, and a provisioning management module 420. The management console 40 enables participants of the services network to collaborate through the establishment enhancement, and/or implementation of Commerce Business Rules and enter into service agreements comprised of one or more Commerce Business Rules. According to a further embodiment, the management console 40 provides the ability to publish commerce services to end-users within the services network through the dynamic services oriented architecture of the payment services network of the present invention.

Commerce business rule management module 410 provides the ability to establish, enhance, and implement Commerce Business Rules. According to one embodiment of the present invention, Commerce Business Rules are created by selecting and establishing values for commerce business attributes.

Commerce business rule attributes may include, for example, specific commerce services for association, descriptive attributes such as name and/or summary description and/or verbose description, units of measurement for exchange (i.e. fees) within a specific pre-defined category of units of measurement for exchange, collaboration attributes for defining whether participants can enhance the Commerce Business Rule, collaboration attributes for defining which attributes can be enhanced and within what value limitations, collaboration attributes for defining whether or not new Commerce Business Rules can be added to the object containing the Commerce Business Rules, such as a service agreement, collaboration attributes for defining which attributes may be selected when new Commerce Business Rules are added to the containing object, and attributes that bind participants or end-user identities to the Commerce Business Rule.

FIG. 4B shows the commerce business management console module, according to a further embodiment of the present invention. The embodiment of the Commerce Business Rule management module 410 as shown in FIG. 4B further comprises a database of identity tokens 421, a database of participants within the services network 423, a database of end-user Sockets 425, a first association module 430 for associating identity tokens to end-user Sockets, a second association module 432 for associating end-user Sockets to Commerce Business Rules, and an implementation module 434 for implementing Commerce Business Rules for transactions originated by end-user Sockets.

FIG. 4C shows the commerce business rule management console module, according to a further embodiment of the present invention. The embodiment of the Commerce Business Rule management module 410 as shown in FIG. 4C further comprises a database of participants within the service network 423, a database of Commerce Business Rules 427 available within the services network, a first association module 442 for associating participants with one or more roles, a hierarchy module 444 for building and managing a hierarchy of Commerce Business Rules where the hierarchy is governed by Commerce Business Rules, a second association module 446 for associating participants and specific roles of the participants with Commerce Business Rules within the rules hierarchy.

FIG. 4D shows the commerce business management console module, according to a further embodiment of the present invention. The embodiment of the Commerce Business Rule management module 410 as shown in FIG. 4D further provides a database of available Commerce Business Rules 427, a hierarchy module 450 for determining a hierarchy of rules, and a rating module 452 for calculating collections and distributions of units of measure for exchange based on the rules hierarchy.

Returning to FIG. 4A, service agreement management module 412 manages the creation and execution of service agreements. According to a further embodiment of the present invention, service agreements contain Commerce Business Rules, and may also include descriptive attributes of the service agreement.

The provisioning management module 420 manages the publishing and delivery of commerce service offerings. Service offerings contain one or more service agreements and may also include descriptive attributes of the service offering. When service offerings are ready for publication, the service offerings may then be registered with the payment services network.

The Socket management module 414 manages a localized Socket registry 415 to bind identity tokens to unique Sockets, and associated end-users and participants within the payment services network and to authenticate transactions originated by the Sockets within the services network. The Socket management module synchronizes it's localized registry 415 with a master registry within the services network.

Commerce services management module 416 manages a localized commerce services registry 417 of services and Service Bundles. The commerce service management module 418 provides the ability to register available commerce services and Service Bundles with the localized commerce services registry 417. The commerce services management module 416 synchronizes it's localized registry 417 with a master registry within the services network. Available services and Service Bundles can then be identified through a query of the localized commerce service registry 417 or master registry within the services network.

In a further embodiment, dynamic messaging capabilities are provided by the commerce services management module 418. In such an embodiment, participants of the services network may dynamically message other participant and end-users regarding the availability of commerce services and provide the ability to request activation of such commerce services.

FIG. 4E shows the management console module, according to a further embodiment of the present invention. The management console module as shown in FIG. 4E further provides a campaign management module 418 for managing campaigns of available commerce services or Service Bundles. According to this embodiment, a campaign refers to a discrete and targeted message regarding an available commerce service or Service Bundles. In such an embodiment a database of participants 460 in the services network is provided. A targeted messaging module 419 is also provided to associate the commerce services identified in the services registry 417 and the participants identified in the database of participants 460, or to associate the Service Bundles identified in the services registry 417 and the end-users targeted by the participants. A database of campaigns 462 is also provided. Accordingly, a participant may target a commerce service to specific participants or a Service Bundles to specific end-users.

In a further embodiment of the present invention, the commerce service management module 416 further enables the provisioning of existing or future payment services within an abstract service classes supported by a Socket. Accordingly, upgrading of the existing Socket application would not be necessary. Furthermore, multiple commerce services or Service Bundles may be provisioned simultaneously across disparate service classes.

In such an embodiment, the commerce services registry 417 includes a database of available services, a database of service agreements, a database of Service Bundles and associated service agreements, an associating module for associating Service Bundles with end-users associated with an active status attribute.

In a further embodiment incorporating dynamic services oriented architecture, the commerce service management module 416 provides a Service Bundle identification module 470 for determining the Service Bundles that have been activated and the end-user Sockets associated with the identified Service Bundles. In such an embodiment a provisioning management module 420 is provided for provisioning activated services to end-user Sockets via the dynamic service oriented architecture.

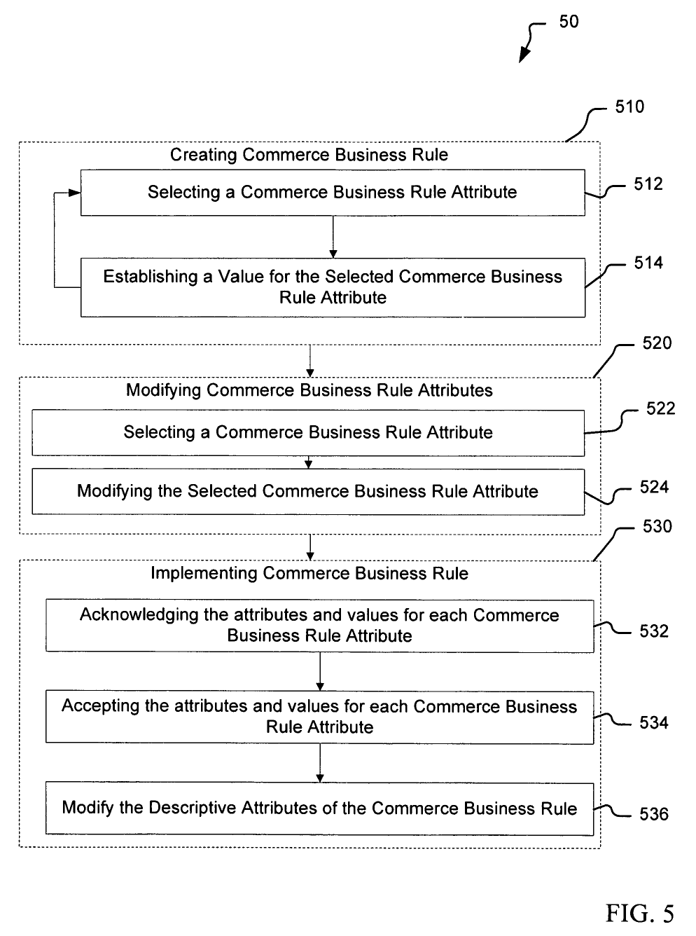

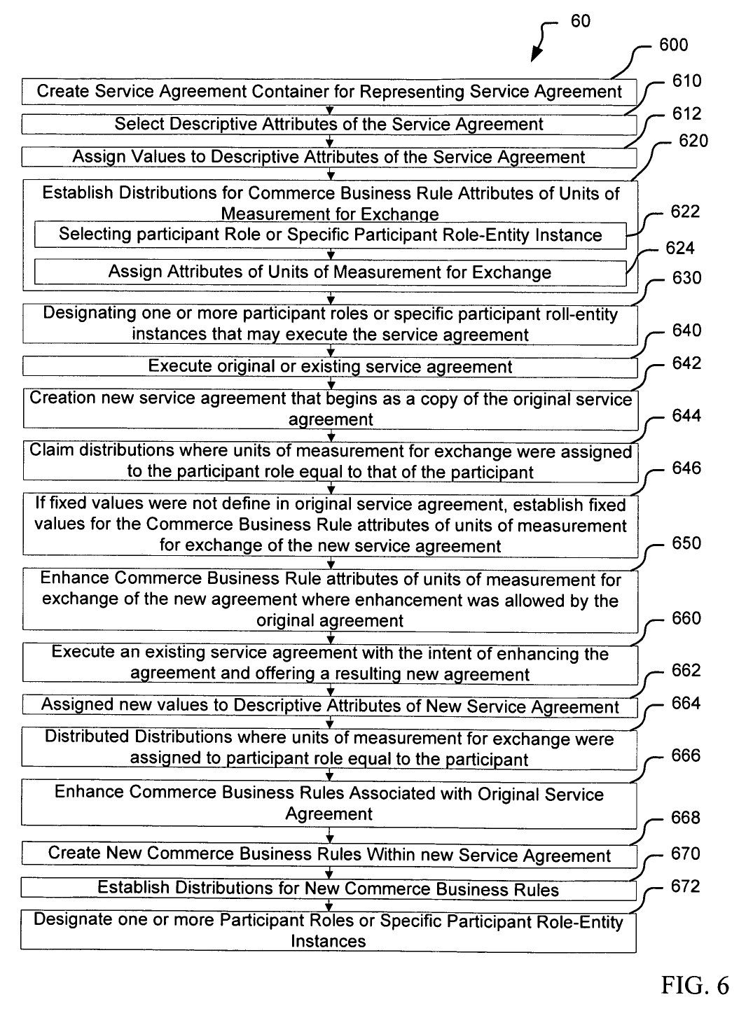

FIG. 5 is a flow diagram showing a method for managing Commerce Business Rules according to an embodiment of the present invention. The process of managing Commerce Business Rules includes the creation and modification of Commerce Business Rules.

Turning to FIG. 5, the method for managing Commerce Business Rules 50 begins with process 510 with the creation of a new Commerce Business Rule. According to one embodiment, process 510 begins at step 512 with selecting a Commerce Business Rule attribute. Process 510 continues at step 514 with establishing a value for the selected Commerce Business Rule attribute.

According to a further embodiment of the present invention, the attributes selected in step 512 may include a specific commerce services for association attribute, a descriptive attribute such as name and/or summary description and/or verbose description, a units of measurement for exchange (i.e. fees) attribute within a specific pre-defined category of units of measurement for exchange, a collaboration attribute that defines whether participants may enhance the Commerce Business Rule, a collaboration attribute that defines which attributes can be enhanced and within what value limitations, a collaboration attribute that defines whether or not the Commerce Business Rule can be added to an object containing the Commerce Business Rule, such as a service agreement, a collaboration attribute defining which attributes can be selected when the Commerce Business Rule is added to the containing object, an attribute that binds participants or end-user identities to the Commerce Business Rule.

In a further embodiment, the method of managing Commerce Business Rules may continue with process 520 for modifying the Commerce Business Rule attributes. Process 520 for modifying the Commerce Business Rule attributes begins at step 522 with the selection of a Commerce Business Rule attribute. At step 524, the selected attribute is modified. The modification of an attribute may include entering a value for an attribute that contains a null value or changing a pre-existing value of the attribute to a new value. In a further embodiment the selected attribute may only be modified within limitations defined for the selected attribute by a collaboration attribute of the Commerce Business Rule.

In a further embodiment, the method of managing Commerce Business Rules continues with process 530 for implementing the Commerce Business Rule. According to one embodiment, the process 530 for implementing a Commerce Business Rule begins at step 532 with acknowledging the Commerce Business Rule, including its selected attributes their values. Process 530 continues at step 534, with accepting the Commerce Business Rule, its attributes and their values. In a further embodiment, the process of implementing a Commerce Business Rule continues at step 536 with the modification of a descriptive attribute of the Commerce Business Rule.

FIG. 6 is a flow diagram showing a method for creating and executing service agreements containing one or more Commerce Business Rules, according to an embodiment of the present invention. The method of FIG. 6 begins at step 600 with the creation of a service agreement. The service agreement of the present invention provides a container for one or more Commerce Business Rules. At step 610, descriptive attributes of the service agreement are selected and at step 612 values are assigned to the descriptive attributes. At step 620, distributions for Commerce Business Rule attributes of units of measurement for exchange are established. Such distributions may be established at step 622 by selecting a participant role, such as the role of Sales Channel, for example, or a specific participant role-entity instance, such as Entity A (an organizational entity within the entity hierarchy of Company A that has been assigned a role such as the role of Sales Channel), for example, to whom the attributes of units of measurement for exchange is assigned and then assigning the attributes of units of measurement for exchange at step 624. The process continues at step 630 by designating one or more participant roles or specific participant role-entity instances that may execute the new service agreement.

In a further embodiment, the method of creating and executing service agreements may continue at step 640 with the execution of an original or existing service agreement and the creation of a new service agreement that begins as a copy of the original service agreement at step 642.

Distributions are claimed at step 644 where units of measurement for exchange were assigned to the participant role equal to that of the participant. If fixed values were not defined in the original service agreement as allowed by the Commerce Business Rules of the original agreement, fixed values are established for the Commerce Business Rule attributes of units of measurement for exchange of the new service agreement at step 646.

In a further embodiment, at step 650 the Commerce Business Rule attributes of units of measurement for exchange of the new agreement may be enhanced where enhancement was allowed by the Commerce Business Rules of the original agreement.

In a further embodiment, at step 660, an existing service agreement may be executed with the intent of enhancing the agreement and offering the resulting new agreement, thereby creating a new service agreement that begins as a copy of the original service agreement. At step 662, new values are assigned to the descriptive attributes of the new service agreement as allowed by the Commerce Business Rules of the original agreement. At step 664, distributions may be distributed where units of measurement for exchange were assigned to the participant role equal to that of the participant. At step 666, the Commerce Business Rules associated with the original service agreement may be enhanced as allowed by the Commerce Business Rules of the original agreement. At step 668, new Commerce Business Rules may be created within the new service agreement as allowed by the Commerce Business Rules of the original agreement. At step 670, if new Commerce Business Rules are created, distributions for Commerce Business Rule attributes of units of measurement for exchange for the new Commerce Business Rules are established by specifying the participant role or the specific participant role-entity instance to whom the attributes of units of measurement for exchange is assigned. At step 672, one or more participant roles or specific participant role-entity instances that may execute said new service agreement as allowed by the Commerce Business Rules of the original agreement are designated.

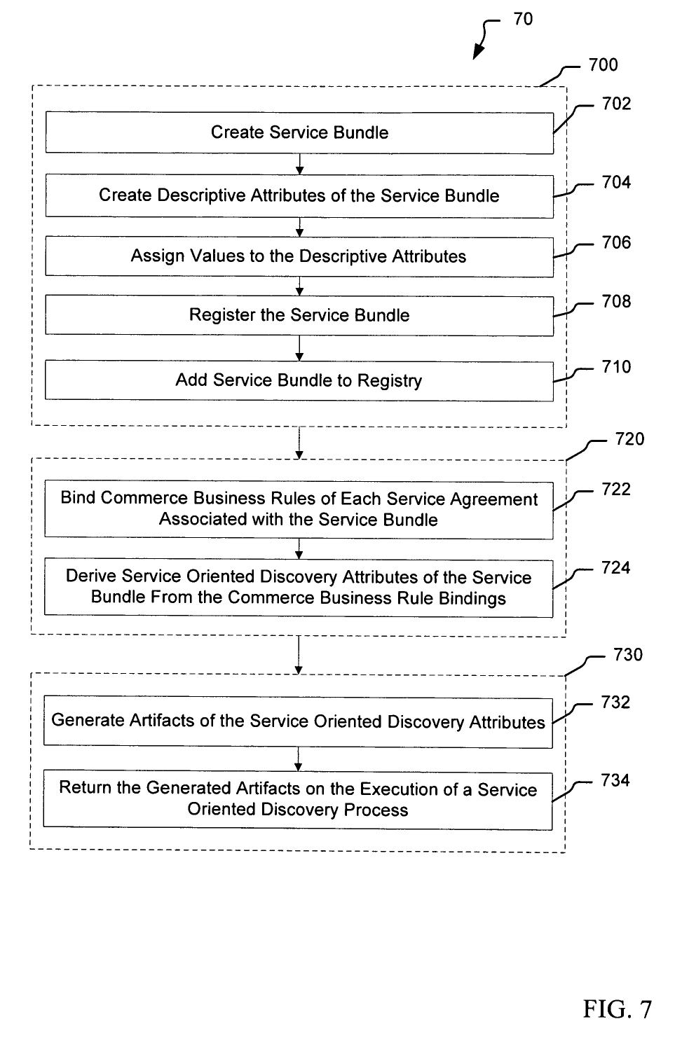

FIG. 7 is a flow diagram showing a method for managing commerce services governed by service agreements comprised of Commerce Business Rules, according to an embodiment of the present invention. The method for management commerce services 70 begins at process 700 for the creation and registration of a service offering or “Service Bundle.” A Service Bundle acts as a container for one or more service agreements that have been executed. Accordingly, the process begins at step 702 with the creation of a Service Bundle. The process continues at step 704 with the selection or creation of descriptive attributes of the Service Bundle. At step 706, values to the selected Service Bundle attributes are assigned. At step 708, the Service Bundle is registered with the services network. At step 710, the Service Bundle is added to a registry of available services.

In a further embodiment, a process of binding Commerce Business Rules with the Service Bundle and deriving service oriented discovery attributes of the bound Service Bundle is provided at step 720. The process begins at step 722 where the Commerce Business Rules associated with each service agreement associated with a Service Bundle are bound to the Service Bundle. Continuing at step 724, service oriented discovery attributes of the Service Bundle are derived based on the Commerce Business Rules bindings.

In a further embodiment, a process for delivery of the commerce services that is facilitated using a dynamic services oriented architecture is provided at 730. Process 730 begins at step 732 with the activation of the Service Bundle triggers the automated process of using service oriented discovery attributes created at step 724 to generate artifacts of the service oriented discovery process. These artifacts include the service oriented configurations, contracts and policies for service consumption and are represented in SOA formats appropriate to the protocols supported for service oriented discovery, for example SOAP and WSDL formats for web services protocols. At step 734, these artifacts are returned to a Socket when a service oriented discovery process is executed.

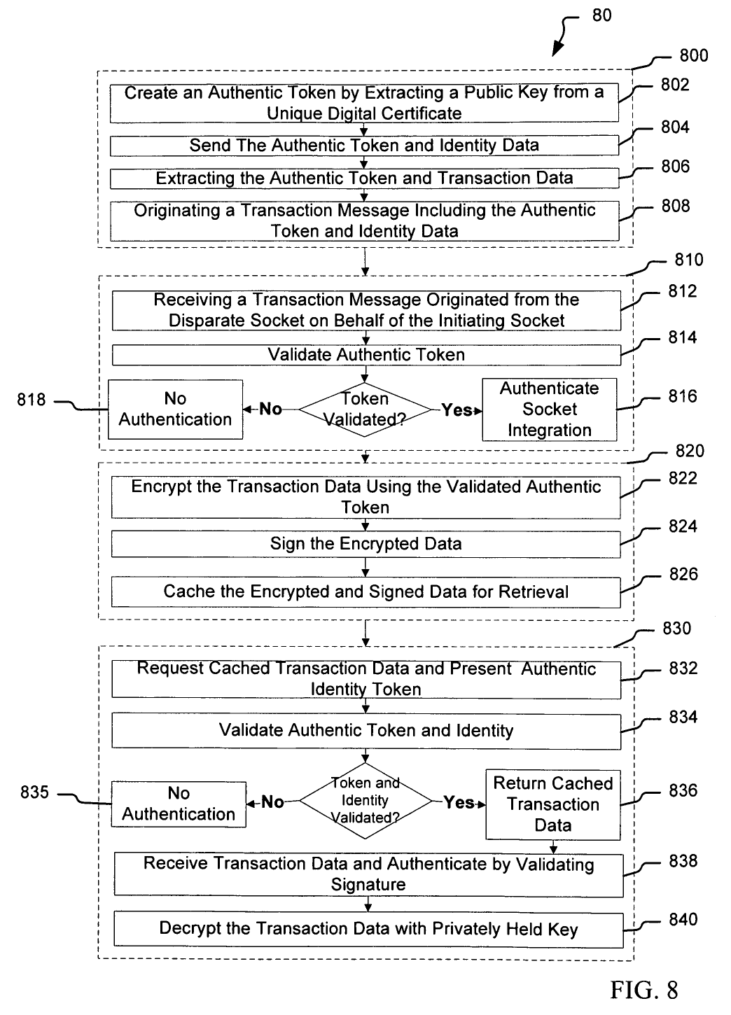

FIG. 8 is a flow diagram showing a method for a first Socket to authenticate itself with a second Socket, according to an embodiment of the present invention. The method for a socket to authenticate itself 80 begins with process 800 for enabling an initiating Socket to provide a disparate Socket with an authentic token to use when transacting within the services network. Accordingly, the initiating Socket and disparate Socket are integrated through the use of this token.

Process 800 begins at step 802 with an initiating Socket creating an authentic token by extracting a public key from a unique digital certificate. At step 804, the initiating Socket sends the authentic token and identity data to a disparate Socket. The identity data is later used by the disparate Socket to originate a transaction onto the services network on behalf of the initiating Socket. At step 806, the disparate Socket extracts the authentic token and transaction data. At step 808, the disparate Socket originates a transaction onto the services network including the authentic token and identity provided by the initiating Socket.

In a further embodiment, the method continues with a process for authenticating the integration of two Sockets when a transaction is originated on behalf of the initiating Socket by the disparate Socket at 810. The process begins at step 812 with the services network receiving a transaction message originated from the disparate Socket on behalf of the initiating Socket. The transaction message contains the authentic token identifying the initiating Socket. The method continues at step 814, by validating the authentic token. If the authentic token is validated, the integration of the initiating and disparate Socket is authenticated at step 816. If the authentic token is not validated the integration is not authenticated at step 818.

In a further embodiment the method continues with process 820 for securely caching transaction data so that only the initiating Socket can retrieve the cache data. The process begins at step 822 with the encryption of transaction data using the validated authentic token. At step 824, the services network signs the encrypted data. At step 826, the services network caches the encrypted and signed data for retrieval by the initiating Socket.

In a further embodiment the method continues with process 830 for enabling the initiating Socket to securely retrieve the cached transaction data. The process begins at step 832 with the initiating Socket presenting an authentic identity token when requesting cached transaction data. At step 834, the services network validates the token and the identity of the initiating Socket. If the token and identity are not validated, no authentication is provided at step 835. If the token and identity are validated, the cached transaction data is returned at step 836 and the process continues to step 838. At step 838 the initiating Socket receives the transaction data. At step 838 the initiating Socket authenticates the integrity of cached transaction data by validating the signature. At step 840 the initiating Socket decrypts the cached transaction data using the privately held key associated with the authentic token used to encrypt the data.

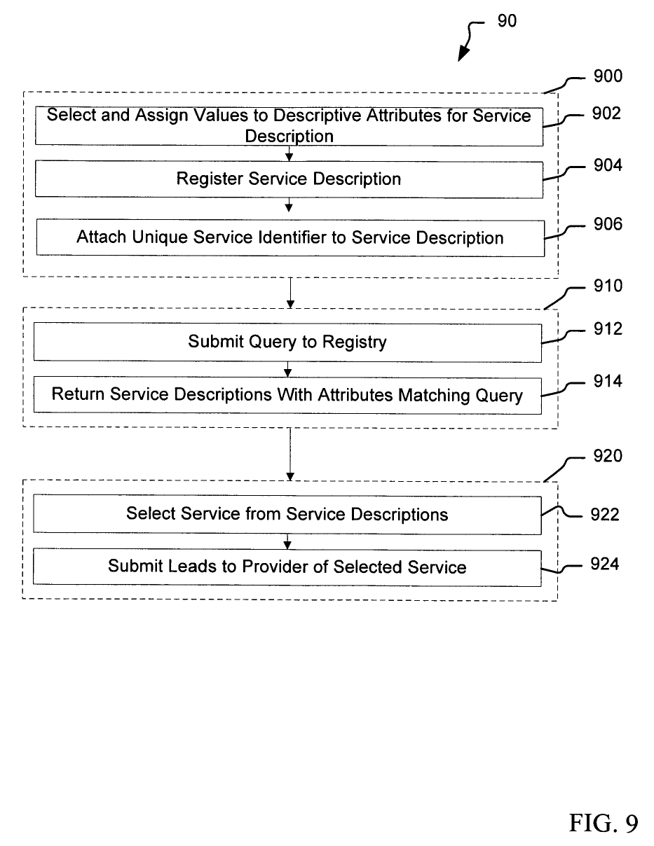

FIG. 9 is a flow diagram showing a method for managing commerce services. The method for managing commerce services 90 begins with a process 900 for publishing available services. The process begins at 902 with the selection and assignment of values to descriptive attributes of a commerce service to a service description. At step 904, the service description of the commerce service is registered with a registry. At step 906, a unique service identifier is attached to the service description.

In a further embodiment, the method for managing commerce services continues at process 910 for querying the registry for available commerce services. The process begins at step 912 with the submission of a query to the registry. According to one embodiment, the query is submitted from a system within a services network. According to a further embodiment, the query is submitted by participants or end-users of the services network via a query tool provided by the services network. In another embodiment, the query is comprised of specific service attribute criteria. At step 914, the registry returns service descriptions for available services in the registry with attributes matching said criteria.

In a further embodiment, the method of managing commerce services continues with process 920 for participants to express interest in collaborating with the providers of the commerce services published within the registry to deliver the services to end-users. The process begins at step 922 with participants selecting services from the service descriptions to express interest in collaborating with the provider of the services. At step 924, participants submit leads to the providers of the selected services through the services network. According to a further embodiment, participants may use the query tool provided by the services network.

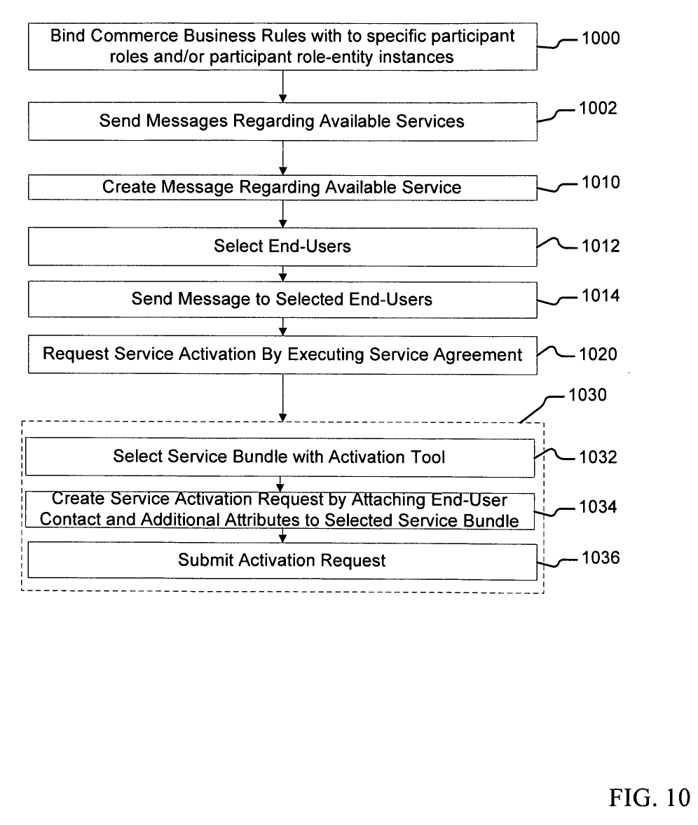

FIG. 10 is a flow diagram showing a method for targeting participants and dynamically messaging the selected participants, according to an embodiment of the present invention. The method for targeting specific participants and end-users of the service network via a dynamic message regarding the availability of commerce services is provided. The method begins at step 1000 with the binding of Commerce Business Rules to specific participant roles and/or participant role-entity instances. At step 1002, messages regarding the availability of a service are sent to participants.

In another embodiment, at step 1010 a participant creates a message regarding the availability of commerce services. At step 1012 the participant selects specific end-users for receipt of the message. At step 1014 the services network sends the message to the selected end-users.

In a further embodiment of the present invention, the method provides the end-users with the ability to request activation of services for available commerce services. The method continues at step 1020 with a participant requesting activation of a service with the execution of a service agreement.

In a further embodiment, systems within the services network provide a services activation tool at step 1030 for use by participants and end-users of the services network. At step 1032, end-users select a Service Bundle with the activation tool. The associated services and service agreements of the Service Bundle will be inherited with the Service Bundle. At step 1034, a service activation request is created with the activation tool by attaching end-user contact and additional attributes to selected Service Bundles. At step 1036, end-users submit the activation request into the services network.

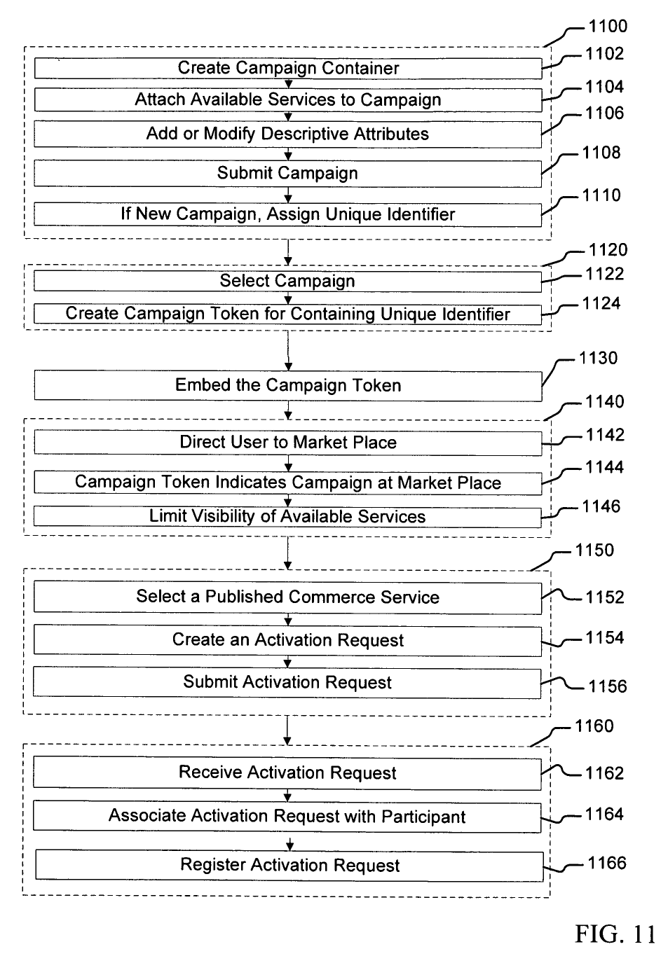

FIG. 11 is a flow diagram showing a method for managing a campaign, according to an embodiment of the present invention. The method for managing a campaign begins with a process for creating a campaign at step 1100. The process begins at step 1102 with creating a container for a new campaign. In a further embodiment, the creation step 1102 may comprise the selection of an existing campaign. At step 1104, specific available services are attached to the campaign. At step 1106, descriptive attributes of the campaign are added or modified. At step 1108, the new or modified Campaign is submitted to the services network. If the campaign is a new campaign, the process continues at step 1110 with a unique identifier being assigned to the new campaign instance.

In a further embodiment, the method of managing a campaign continues at process 1120 for pushing a campaign to an end-user Socket. The process begins at step 1122 with a specific campaign being selected. At step 1124, a campaign token containing the unique identifier is created.

In a further embodiment, the method of managing a campaign continues at step 1130 with the step of embedding the campaign token. In one embodiment, the step of embedding a campaign token further comprises embedding the campaign token into an end-user Socket prior to distribution of Socket to end-user. In another embodiment, the step of embedding a campaign token further comprises embedding the campaign token in a URI used in email, web page, or other electronic mediums promoting campaign. In a further embodiment, the step of embedding a campaign token further comprises embedding the campaign token into any non-Socket application capable of directing an end-user to a market place within the services network.

In another embodiment, the method of managing a campaign further includes process 1140 for limiting the publishing of service availability to end-users based on campaign attributes. The process begins at step 1142 with an end-user being directed to a market place within the services network. At step 1144, the campaign token indicates a campaign instance to the market place. At step 1146, end-user visibility of available commerce services is limited to services defined by the campaign attributes within the campaign instance.

In a further embodiment, the method of managing a campaign further includes process 1150 for requesting activation of a targeted commerce service published through a campaign. The process begins at step 1152, with the selection of a published commerce service. At step 1154, an activation request is created by attaching end-user contact and additional attributes to the service agreement of the selected commerce service. At step 1156, a request for activation is submitted into the services network.

In a further embodiment, the method of managing a campaign further includes a process 1160 for enabling participants to source end-user leads originated with the service activation requests. The process begins at step 1162, an instance of an payments framework platform in the services network receives the activation request. At step 1164, the payments framework platform associates activation requests with the participant that established the campaign instance. At step 1166, the platform registers an activation request with a lead sourcing application provided to the participant.

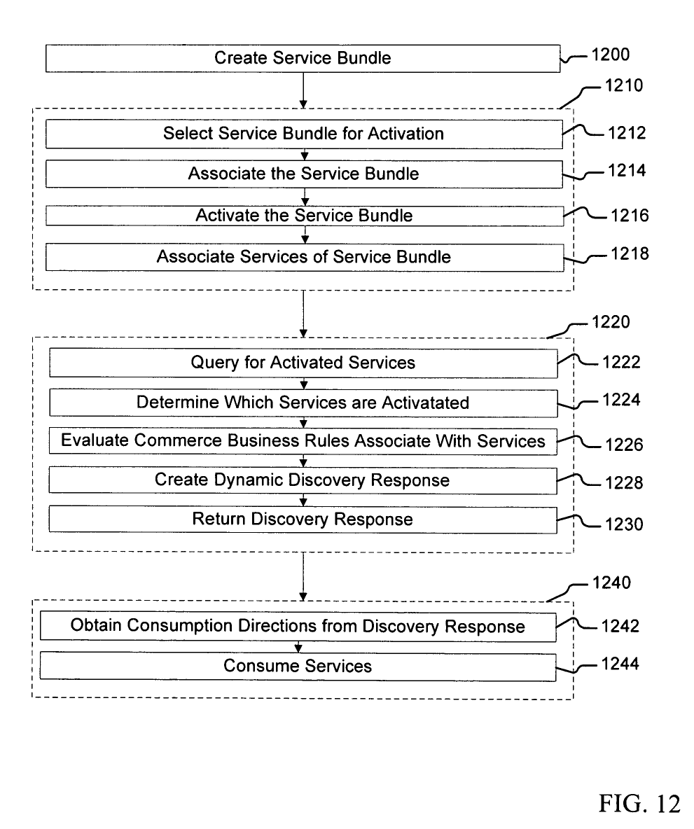

FIG. 12 is a flow diagram showing a method for managing Service Bundles based on Commerce Business Rules, according to an embodiment of the present invention. The method for managing Service Bundles begins at step 1200 with creating a Service Bundle. The method continues with process 1210 for activating a Service Bundle to one or more Sockets. The process begins at step 1212 with the selection of a Service Bundle for activation. The process continues at step 1214 with the association of the Service Bundle to an end-user or specific end-user Socket. At step 1216, activation of the Service Bundle is established with the end-user or specific end-user Socket. At step 1218, services of the Service Bundle are associated to the end-user or specific end-user Sockets.

In a further embodiment, the method for managing Service Bundles further includes a process 1220 for locating activated services and attributes of the activated services by end-user Sockets based on Dynamic Service Orientation through Commerce Business Rules. The process begins at step 1222 when an end-user Socket queries the services network for activated services and attributes of the activated services. At step 1224, the services network determines which services have been activated for end-user or specific end-user Socket. At step 1226, the services network evaluates Commerce Business Rules associated with the services. At step 1228, the services network creates dynamic discovery response based on attributes of the Commerce Business Rules. At step 1230, the services network returns a discovery response.

In a further embodiment, the method for managing Service Bundles further includes process 1240 for directing a Socket to consume the services and Service Bundles through Dynamic Service Orientation. The process begins at step 1242 by obtaining directions for consumption of said services and Service Bundles from the discovery response returned in step 1230. At step 1244, the Socket consumes the services and Service Bundles by configuring an associated Socket application instance to enable the services and services associated with the Service Bundles.

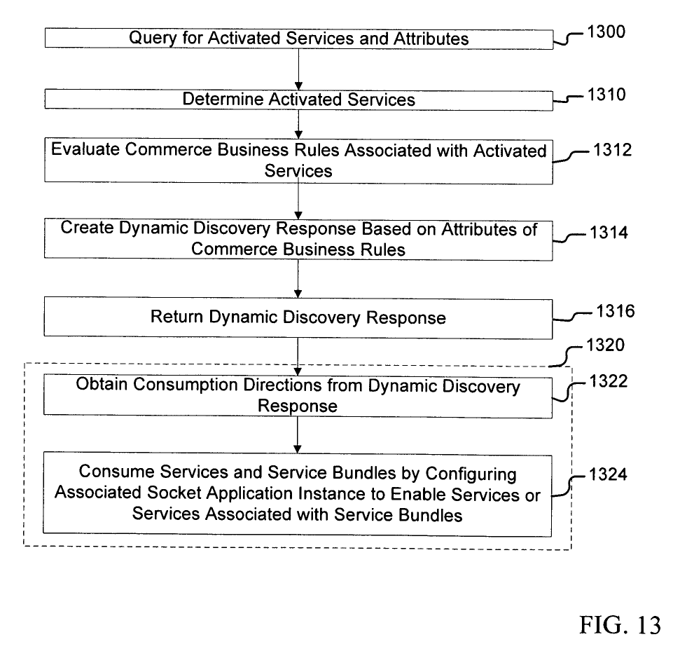

FIG. 13 is a flow diagram showing a method for facilitating the discovery of services and Service Bundles, according to an embodiment of the present invention. The method begins at step 1300 with an end-user socket querying the Services Network for activated services and attributes thereof (“Discovery”). At step 1310, the services network determines which services have been activated for end-user or specific end-user socket. At step 1312, the services network evaluates Commerce Business Rules associated with the identified services. At step 1314, the services network creates a dynamic a discovery response based on attributes of the associated Commerce Business Rules. At step 1316, the services network returns Discovery response.

In a further embodiment, the method continues with process 1320 for directing a Socket to consume the services and Service Bundles through Dynamic Service Orientation. The process begins at step 1322 with the Discovery response defined in method of claim 5 includes directions for consumption of said services and Service Bundles. The process continues at step 1334 with the Socket consuming the services or Service Bundles by configuring an associated socket application instance to enable the services or services associated with the Service Bundles.

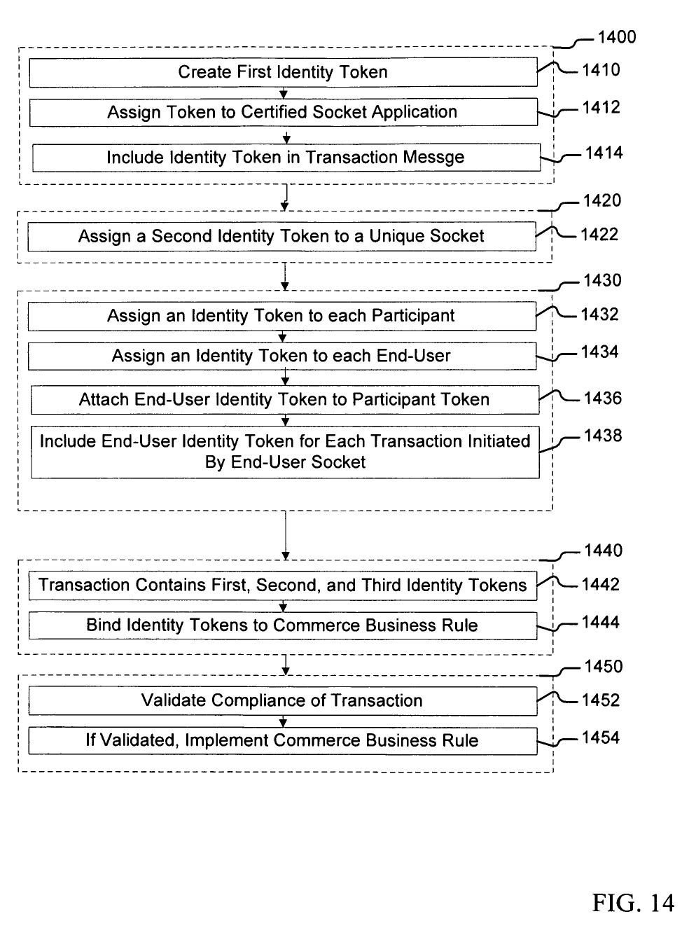

FIG. 14 is a flow diagram showing a method for binding a Socket application to Commerce Business Rules, according to an embodiment of the present invention. The method for binding begins at step 1400 with a process for creating an identity token. The token creation process includes process 1410 for creating a first identity token for binding the identity of a Socket application to the transactions initiated by the Socket application. The process begins with the certification of a Socket application for use within a services network. At step 1412, the certified Socket application is assigned a unique identity token. At step 1414 the certified Socket application includes the unique identity token in a transaction message of a transaction initiated by the Socket application.

The method for binding further includes process 1420 for creating a second identity token for binding the identity of a unique Socket application instance to each transaction initiated by the Socket application instance. The process begins at step 1422 by assigning an identity token to a unique Socket application instance. In one embodiment, the assignment of the identity token may take place at the time of distribution of a unique Socket application instance. According to a further embodiment, the assignment of the identity token may take place at the time of installation of the unique Socket application instance.

The method for binding further includes process 1430 for creating a third identity token for binding the identities of the end-user and the participant of the services network who activated the end-user within the services network to the Socket application instance and each transaction initiated by the Socket application instance. The process begins at step 1432 by assigning each participant within the services network a unique identity token. At step 1434, each end-user within the Services Network is assigned a unique identity token. At step 1436, each end-user identity token is attached to the identity token of the participant who activated the end-user within the services network. At step 1438, the transactions initiated by a Socket application of the end-user includes the end-user identity token.

In a further embodiment, the method for binding further includes process at 1440 for binding the Socket application instance associated with the end-user to the Commerce Business Rules established by the participant of the service network who activated said end-user within the services network. The process begins at step 1442 with a transaction message originated into the services network by a Socket contains the first identity token, the second identity token and the third identity token. At step 1444, the services network binds the identity tokens to the Commerce Business Rules established by the participant who activated the end-user associated with the Socket within the services network.

In a further embodiment, the method continues with process 1450 for implementing the Commerce Business Rules when a transaction originated by an end-user Socket application instance bound to the Commerce Business Rules are sent into the services network. The process begins at 1452 by validating the compliance of the transaction with the Commerce Business Rules bound to the first, second, and third identity tokens. If compliance is validated the process continues at step 1454 by implementing the Commerce Business Rules.

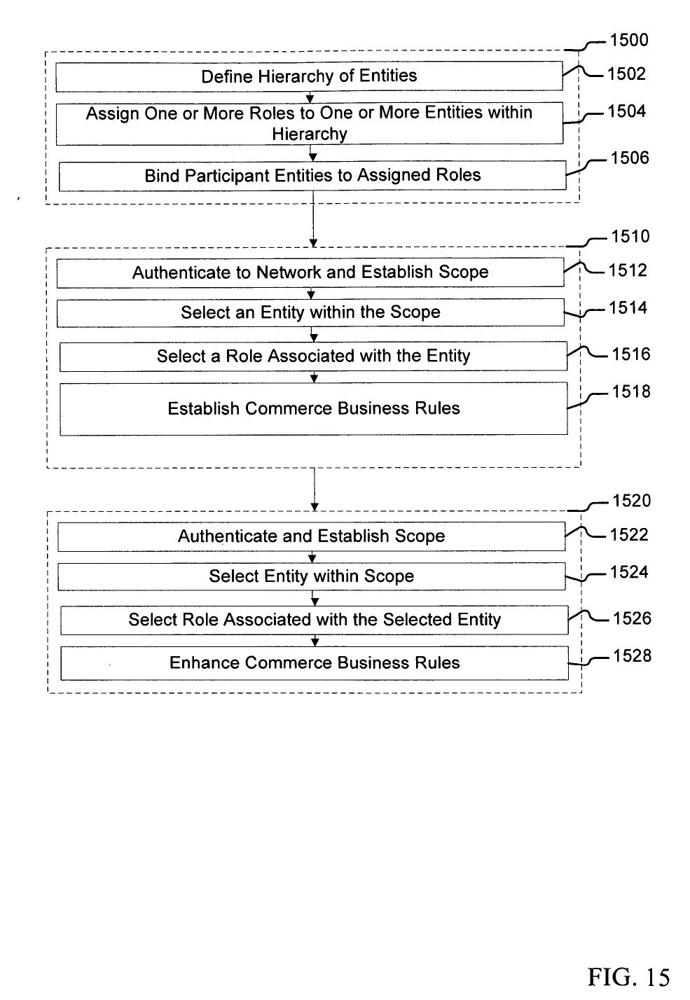

FIG. 15 is a flow diagram showing a method for managing participant roles, according to an embodiment of the present invention. The method for binding includes process 1500 for binding participants to one or more roles. The process begins at step 1502 when a participant within the services network defines a hierarchy of entities associated with their organization within the services network. At step 1504, the participant assigns one or more roles to one or more entities within the defined hierarchy. At step 1506, the services network binds the participant entities to the assigned roles by creating a unique participant role-entity instance.

In a further embodiment, the method for managing participant roles further includes process 1520 for implementing Commerce Business Rules. The process begins at step 1512 where participants authenticate to the services network and the services network establishes scope within the participant organization's entity hierarchy within which participants can manage Commerce Business Rules. Scope is determined by evaluating which specific entity a specific participant end-user is associated within the participant organization's entity hierarchy and evaluating permissions (based on standard roles-based-security implementations) for that participant end-user to determine how wide or deep within the entity hierarchy the end-user has permission to manage business rules. The resulting set of entities that a specific participant end-user has permissions to manage business rules on behalf of is the scope. At step 1514, the participant selects an entity within the scope. At step 1516, the participant selects a role associated with the entity. At step 1518, the participant establishes Commerce Business Rules associated with the selected unique participant role-entity instance and/or implements the Commerce Business Rules.

In a further embodiment, the method for managing participant roles further includes process 1520 for managing Commerce Business Rules established or enhanced by other participants in the service network and governed by the Commerce Business Rules within the resulting rule hierarchy. The process begins at step 1522 where participants authenticate to the services network and the services network establishes scope within the participant organization's entity hierarchy within which participants can manage Commerce Business Rules. At step 1524, the participant selects an entity within the scope. At step 1526, the participant selects a role associated with the entity. At step 1528, the participant enhances Commerce Business Rules offered to the selected unique participant role-entity instance or implements Commerce Business Rules offered to selected participant role-entity instance.

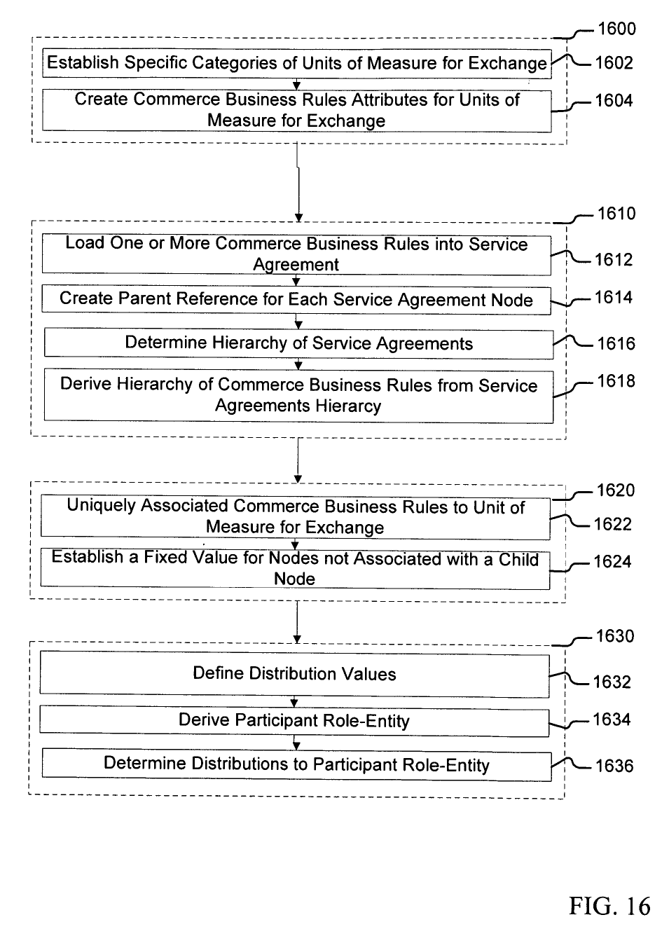

FIG. 16 is a flow diagram showing a method for rating (determining collections and distributions of units of measure for exchange). The method includes process 1600 for categorizing attributes of Commerce Business Rules by units of measure for exchange. The process begins at 1602 where the services network establishes specific categories of units of measurement for exchange. At step 1604, participants within the services network creating Commerce Business Rules attributes of units of measurement for exchange assign specific attribute instances to specific categories of units of measurement for exchange.

In a further embodiment, the method further includes process 1610 for determining a hierarchy of Commerce Business Rules. The process begins at step 1612 where one or more Commerce Business Rules are contained within a service agreement. At step 1614, each node in a group of service agreements, other than the root node, creates a parent reference to its parent node. At step 1616, the services network evaluates the parent references of the nodes to determine a hierarchy of service agreements. At step 1618, a hierarchy of Commerce Business Rules is derived for each Commerce Business Rule attribute common to two or more service agreements within the service agreement hierarchy.

The method further includes process 1620 for determining the cumulative totals of units of measure for exchange represented by the Commerce Business Rules hierarchy in each category of units of measure. The process begins at 1622 where an instance of a hierarchy of Commerce Business Rules associated with a Commerce Business Rule attribute related to a unit of measurement of exchange is unique to one and only one category of unit of measure for exchange. At step 1624, each node within the hierarchy not associated with a child node establishes a fixed value for the cumulative total of the hierarchy.

The method further includes process 1630 for determining how the cumulative totals of units of measure for exchange in category are distributed to individual participants and/or end-users based on the rules defined in the Commerce Business Rules hierarchy. The process begins at 1632 where each node within the hierarchy instance node defines distribution values based on fixed amounts or percentage share of the cumulative total defined by the hierarchy and associates the distribution value with a participant role or specific participant role-entity instance. At step 1634, the services network derives the specific participant role-entity instance to associate distribution values associated with a participant role by attaching the specific participant role-entity instance associated with the child node of the node where the distribution value associated with a participant role is defined. At step 1636, the services network determines distributions to the participant role-entity instance by attaching a defined fixed value or a value calculated by the percentage of the cumulative total of the hierarchy.

It will be apparent to those skilled in the art that various modifications and variations can be made in the present invention without departing from the spirit or scope of the invention. Thus, it is intended that the present invention cover the modifications and variations of this invention provided that they come within the scope of any claims and their equivalents.

What is claimed is:

1. An IP payments platform, comprising:
a business and policy administration module for managing the use of commerce business rules, service agreements, applications, and provisioning of the IP payments platform,
a service broker for managing the connections with peered instances of the IP payments platform, participants, and users,
a socket administration and monitoring module for managing sockets,
a systems and event management module for platform management and operations support,
a rating engine,
a data mart for managing a reporting service interface, and
an application programming interface for integrating third-party applications with platform business logic and data management.

2. The IP payments platform of claim 1, wherein the business and policy administration module further comprises a management console for managing commerce services, service agreements, and sockets.

3. The IP payments platform of claim 2, wherein the management console further comprises a commerce business rule management module for establishing, enhancing, and implementing commerce service rules.

4. The IP payments platform of claim 3, wherein the commerce business rule management module further comprises:
an identity token database for storing identity tokens available within one or more interconnected IP payments platforms,
a participants database for storing the participants within one or more interconnected IP payments platforms,
an end-user sockets database for storing end-user socket information identifying the end-user sockets available within one or more IP payments platforms,
a first association module for associating the identity tokens in the identity tokens database to the end-user socket information stored in the end-user sockets database,
a second association module for associating the end-user socket information to commerce business rules, and
an implementation module for implementing commerce business rules for transactions originated by an end-user socket.

5. The IP payments platform of claim 3, wherein the commerce business rule management module further comprises:
a participants database for storing the participants within one or more interconnected IP payments platforms,
a commerce business rules database for storing information regarding commerce business rules available within one or more interconnected IP payments platforms,
a first association module for associating the participants with one or more roles,
a hierarchy module for building and managing a hierarchy of commerce business rules, and
a second association module for associating the participants and specific roles of the participants with commerce business rules within the hierarchy of commerce business rules.

6. The IP payments platform of claim 3, wherein the commerce business rule management module further comprises:
a database of available commerce business rules,
a hierarchy module for determining a hierarchy of the commerce business rules, and
a rating module for calculating collections and distributions of units of measure for exchange.

7. The IP payments platform of claim 3, wherein the management console further comprises:
a service agreement management module for managing the creation and execution of service agreements,
a socket management module for managing sockets,
a socket registry interconnected with the socket management module for identifying available sockets with one or more interconnected IP payment platforms,
a commerce services management module for management commerce services and service bundles,
a services registry interconnected with the commerce service management module for identifying the commerce services available within one or more interconnected IP payment platforms.

8. The IP payments platform of claim 3, wherein the management console further comprises:
a campaign management module for managing campaigns of available commerce services or service bundles,
a services registry for storing the identity of available services or service bundles,
a participants database for storing the identity of participants and
a targeted messaging module for associating commerce services and participants identified in the participants database.

9. The IP payments platform of claim 3, wherein the management console further comprises:
a campaign management module for managing campaigns of available commerce services or service bundles,
a services registry for storing the identity of available services or service bundles,
a participants database for storing the identity of participants and
a targeted messaging module for associating services and service bundles identified in the services registry and end-users targeted by participants.

10. The IP payments platform of claim 3, further comprising a provisioning management module for the management of provisioning existing or future payment services within one or more abstract service classes supported by a socket.

11. The IP payments platform of claim 3, wherein the commerce business rule management module further comprises a service bundle identification module for determining the service bundles that have been activated and the end-user sockets associated the identified service bundles.

12. A method for managing commerce business rules, comprising the steps of:
selecting a commerce business rule attribute; and
establishing the value of the selected commerce business rule attribute.

13. The method of claim 12 wherein the step of selecting a commerce business rule attribute further comprises selecting the commerce business attribute from a list consisting of:
specific commerce services for association attribute,
a descriptive attribute,
a summary description attribute.
a verbose description attribute,
a units of measurement for exchange attribute,
an attribute to bind participants or end-user identities to the commerce business rule, and
a collaboration attribute.

14. The method of claim 13, wherein the collaboration attribute is selected from the group consisting of:
a collaboration attribute defining whether participants can enhance the Commerce Business Rule;
a collaboration attribute defining attributes that can be enhanced;
a collaboration attribute within specified value limitations;
a collaboration attribute that defines whether or not new Commerce Business Rules can be added to the object containing the Commerce Business Rules, such as a service agreement; and
a collaboration attribute that defines which attributes can be selected when new Commerce Business Rules are added to the containing object.

15. The method of claim 12, further comprising the step of modifying an attribute of the commerce business rule within limitations defined by a collaboration attribute.

16. The method of claim 15, wherein the step of modifying an attribute further comprises the steps of:
selecting a commerce business rule attribute, and
modifying the value of the selected commerce business rule attribute.

17. The method of claim 12, further comprising the steps of:
acknowledging the one or more assigned attributes; and
acknowledging the established values of the one or more attributes.

18. The method of claim 12, further comprising the step of modifying a descriptive attribute.

19. A method for enabling participants in a services network to execute service agreements, the method comprising the steps of:
creating one or more commerce business rules;
creating a service agreement container for the one or more commerce business rules;
selecting descriptive attributes of the service agreement container; and
assigning values to the selected descriptive attributes.

20. The method of claim 19, further comprising the step of establishing distributions for commerce business rule attributes of units of measurement for exchange by specifying a participant role instance for assigning the attributes of units of measurement for exchange.

21. The method of claim 20, wherein the step of establishing distributions further comprising the steps of:
selecting a participant role or a specific participant role-entity instance, and
assigning attributes of units of measurement for exchange.

22. The method of claim 21, further comprising the step of designating one or more participant roles or specific participant role-entity instances that may execute the service agreement.

23. The method of claim 19, further comprising the steps of:
executing an existing service agreement thereby creating a new service agreement that begins as a copy of the original service agreement;
obtaining distributions where units of measurement for exchange are assigned to the participant role equal to that of the participant; and
establishing fixed values for Commerce Business Rule attributes of units of measurement for exchange where fixed values have not been defined in the original agreement as allowed by the Commerce Business Rules of the original agreement.

24. The method of claim 23, further comprising the step of enhancing the commerce business rule attributes of units of measurement for exchange where allowed by the commerce business rules of the original agreement.

25. The method of claim 19, further comprising the steps of:
executing an existing service agreement with the intent of enhancing the agreement and offering the resulting new agreement to other participants, thereby creating a new service agreement that begins as a copy of the original service agreement;
assigning new values to the descriptive attributes of the new service agreement as allowed by the commerce business rules of the original agreement; establishing distributions for commerce business rule attributes of units of measurement for exchange for new commerce business rules by specifying the participant role or the specific participant role-entity instance to whom the attributes of units of measurement for exchange are assigned; and
designating one or more participant roles or specific participant role-entity instances for executing the new service agreement as allowed by the commerce business rules of the original agreement.

26. The method of claim 19, further comprising the step of claiming distributions where units of measurement for exchange were assigned to the participant role equal to that of the participant.

27. The method of claim 19, further comprising the step of enhancing the commerce business rules of the original service agreement by modifying attributes within the bounds of the limitations defined by collaboration attributes as defined by the commerce business rules of the original agreement.

28. The method of claim 19, further comprising the steps of creating new commerce business rules within the new service agreement as allowed by the commerce business rules of the original agreement.

29. A method for publishing commerce services, comprising the steps of:
creating a service offering container for one or more service agreements;
selecting descriptive attributes of the service offering container
assigning values to the selected descriptive attributes of the service offering container;
registering the service offering; and
adding the service offering to a registry of available services.

30. The method of claim 29, further comprising the steps of:
binding the commerce business rules of each service agreement associated with a service bundle to the service bundle; and
deriving service oriented discovery attributes of the service bundle based on the commerce business rules bindings.

31. The method of claim 30, further comprising the steps of:
implementing the derived service oriented discovery attributes to generate artifacts of the service oriented discovery process; and
providing the artifacts to a socket when the service oriented discovery process is executed.

32. A method for integrating an initiating socket and a disparate socket with an authentic token for use during transactions, the method comprising the steps of:
creating an authentic token by the initiating socket by extracting a public key from a unique digital certificate;
sending the authentic token and identity data of the initiating socket to the disparate socket;
extracting the authentic token and the identity data by the disparate socket; and
providing the authentic token for each transaction originated by the disparate socket.

33. The method of claim 32, comprising the steps of:
sending transaction data by the disparate socket on behalf of the initiating socket, wherein the transaction data contains an authentic token identifying the initiating socket;
receiving the transaction data; and
validating the authentic token to authenticate the integration of the two sockets.

34. The method of claim 33, further comprising the steps of:
encrypting the transaction data using the received and validated authentic token;
signing the encrypted transaction data with a signature; and
caching the encrypted and signed transaction data for retrieval by the initiating socket.

35. The method of claim 34 further comprising the steps of:
presenting the authentic identity token by the initiating socket for requesting cached transaction data;
validating the token and the identity of the initiating socket;
returning the cached transaction data in response to validating the token and the identity of the initiating socket;
receiving the cached transaction data;
authenticating the integrity of the cached transaction data by the initiating socket by validating the signature; and
decrypting the cached transaction data by the initiating socket using the privately held key associated with the authentic token.

36. A method for publishing available services to a registry, the method comprising the steps of:
selecting a descriptive attribute of a commerce service;
assigning values to the selected attribute to a service description;
registering the service description with a registry; and
attaching a unique service identifier to the service description.

37. The method of claim 36, further comprising the steps of:
submitting a query to the commerce services registry, the query composed of specific service attribute criteria; and
returning a service description for each available service in the registry with attributes matching the criteria.

38. The method of claim 37, further comprising the steps of:
providing a registry query tool by a system within a services network for use by participants and end-users; and
creating the query with the registry query tool by specifying service attribute criteria.

39. The method of claim 37, further comprising the steps of:
selecting services from the returned service descriptions to express interest in collaborating with a provider of the services; and
submitting leads to the providers of the selected services through the services network.

40. A method for targeting participants and dynamically messaging the selected participants, comprising the steps of:
establishing one or more commerce business rules;
binding the one or more commerce business rules to specific participant roles and/or participant role-entity instances; and
sending a message regarding the availability of a service.

41. The method of claim 40, further comprising the steps of:
creating a second message regarding the availability of commerce services;
selecting specific end-users for receipt of the second message; and
sending the second message to the selected end-users.

42. A method for requesting activation of a service from available commerce services, comprising the step of executing a service agreement to request activation of a service.

43. The method of claim 42, further comprising the steps of:
providing services activation tools for use by participants and end-users of the services network;
using service activation tools to select service bundles and their associated services and service agreements;
creating a service activation request using the service activation tools to attach an end-user contact and additional attributes to selected service bundles; and
submitting the activation requests with the service activation tools.

44. A method for defining and managing a campaign, comprising the steps of:
selecting a campaign;
specifying available services for the campaign;
adding or changing descriptive attributes of the campaign;
submitting the campaign; and
if the campaign is a new campaign, associating a unique identifier with the campaign instance.

45. The method of claim 44, wherein the step of selecting a campaign further comprises the steps of:
creating a container for a new campaign;
associating a unique identifier with the campaign.

46. The method of claim 45, further comprising the step of adding descriptive attributes of the campaign to the campaign container.

47. The method of claim 45, further comprising the step of changing descriptive attributes of the campaign to the campaign container.

48. The method of claim 45 further comprising the steps of:
selecting the campaign; and
creating a campaign token to contain the unique identifier

49. The method of claim 45, further comprising any of the steps of embedding the campaign token into an end-user socket prior to distribution of socket to end-user.

50. The method of claim 45, further comprising any of the steps of embedding the campaign token in a URL used in email, web page, or other electronic mediums promoting the campaign;

51. The method of claim 45, further comprising any of the steps of: embedding the campaign token into any non-socket application capable of directing an end-user to a market place within a services network.

52. The method of claim 45, further comprising the steps of:
directing end-users to a market place within a services network;
indicating with the campaign token the campaign instance in the market place; and
limiting end-user visibility of available commerce services to services defined by the campaign attributes within the campaign instance.

53. The method of claim 45, further comprising the steps of:
selecting commerce services;
creating an activation request by attaching end-user contact and additional attributes to selected service agreements; and
submitting request for activation.

54. The method of claim 53, comprising the steps of:
receiving the activation request;
associating the activation request with participants that established the associated campaign instance; and
registering the activation request within a lead sourcing application provided to participants.

55. A method for managing service bundles based on commerce business rules, comprising the steps of:
creating a service bundle;
selecting the service bundle for activation;
associating an end-user or specific end-user sockets to the selected service bundle;
establishing activation of the service bundle to the end-user or specific end-users socket; and
associating services within the service bundle to the end-user or specific end-user sockets.

56. The method of claim 55, further comprising the steps of:
querying for activated services and attributes of the activated services;
determining which services have been activated for the end-user or specific end-user socket;
evaluating the commerce business rules associated with the services;
creating a dynamic discovery response based on the attributes of the associated commerce business rules; and
returning the dynamic discovery response.

57. The method of claim 56, further comprising the steps of:
receiving consumption directions from the discovery response; and
consuming the services and service bundles by configuring the associated socket application instance to enable the services and services associated with said service bundles.

58. A method binding the identity of a socket application to a transaction initiated by the socket application, comprising the steps of:
certifying the socket application for use;
assigning a first unique identity token to the certified socket application; and
including the unique identity token in transaction messages with each transaction initiated by the socket application.

59. The method of claim 58, further comprising the step of assigning a second unique identity token to each unique socket application instance.

60. The method of claim 59, wherein the step of assigning an identity token further comprises the step of assigning the identity token at the time of the distribution of the unique socket application instance

61. The method of claim 59, wherein the step of assigning an identity token further comprises the step of assigning the identity token at the time of installation of the unique socket application instance.

62. The method of claim 59, further comprising the steps of:
assigning each participant a unique participant identity token;
assigning each end-user a unique end-user identity token;
attaching end-user identity tokens to the participant identity tokens of the participant who activated the end-user; and
including end-user identity tokens with every transaction initiated by the socket application of the end-user.

63. The method of claim 62, further comprising the steps of:
including the first unique identity token, the second identity token, and the end-user or participant unique identity token with every transaction message originated into the services network by every socket within the services network; and
binding the three unique identity tokens to the commerce business rules established by the participant who activated the end-user associated with the socket within the services network for every transaction message originated into the services network by a socket.

64. The method of claim 63, further comprising the steps of:
validating transaction compliance with the commerce business rules bound to the set of three identity tokens when a transaction is received; and
implementing the commerce business rules.

65. A method for binding participants to one or more roles, comprising the steps of:
defining a hierarchy of entities associated with their organization;
assigning one or more roles to one or more entities within the hierarchy;
binding the entities to the assigned roles by creating a unique participant role-entity instance.

66. The method of claim 65. further comprising the steps of:
authenticating and establishing scope within the organization's entity hierarchy within which participants can manage commerce business rules;
selecting an entity within the scope;
selecting a role associated with the entity;
establishing commerce business rules associated with the selected unique participant role-entity instance and/or implementing the commerce business rules.

67. The method of claim 65, further comprising the steps of:
authenticating and establishing scope within the organization's entity hierarchy within which participants can manage commerce business rules;
selecting an entity within the scope;
selecting a role associated with the entity; and
enhancing commerce business rules offered to the selected unique participant entity and role instance or implement commerce business rules offered to selected participant role-entity instance.

68. A method for managing commerce business rules categorized by units of measure for exchange, comprising the steps of:
establishing specific categories of units of measurement for exchange;
creating commerce business rules attributes of units of measurement for exchange and assigning specific attribute instances to specific categories of units of measurement for exchange.

69. The method of claim 68, further comprising the steps of:
loading one or more commerce business rules in a service agreement;
creating a parent reference for each service node other than the root node within a hierarchy of service agreements;
evaluating the parent-child relationships to determine a hierarchy of service agreements;
deriving a hierarchy of commerce business rules for each commerce business rule attribute common to two or more service agreements within the service agreement hierarchy.

70. The method of claim 69, further comprising the steps of:
uniquely associating an instance of a hierarchy of commerce business rules associated with a commerce business rule attribute related to a unit of measurement of exchange for one category of unit of measure for exchange;
establishing a fixed value for each node within the hierarchy that is not associated with a child node for the cumulative total of the hierarchy.

71. The method of claim 70, further comprising the steps of:
defining distribution values based on fixed amounts each node within the hierarchy instance with an associated child node or percentage share of the cumulative total defined by the hierarchy and associating this distribution value with a participant role or specific participant role-entity instance;
deriving the specific participant role-entity instance to associate distribution values associated with a participant role by attaching the specific participant role-entity instance associated with the child node of the node where the distribution value associated with a participant role is defined;
determining distributions to the participant role-entity instance by either attaching the fixed value defined or calculated by the percentage of the cumulative total of the hierarchy.
